(19) United States
(12) Patent Application Publication
(10) Pub. No.: US 2012/0076895 A1
(43) Pub. Date: Mar. 29, 2012

(54) EXTRUDED FOOD PRODUCTS COMPRISING PROBIOTIC MICRO-ORGANISMS

(75) Inventors: Vygantas Kirejevas, Tallinn (EE); Aram Kazarjan, Tallinn (EE)

(73) Assignee: BACTERFIELD OU, Tallinn (EE)

(21) Appl. No.: 13/265,450

(22) PCT Filed: Apr. 22, 2010
(86) PCT No.: PCT/EP10/55349

§ 371 Date: Nov. 11, 2011

(30) Foreign Application Priority Data
Apr. 23, 2009 (EP) 09158594.3

(51) Int. Cl. A23L 1/30; A23L 1/10; A23P 1/08

(52) U.S. Cl. 426/62; 426/61

(57) ABSTRACT

The present invention relates to a vacuum infused synbiotic human extruded food product having 1) a density of 1 g/L to 1000 g/L at RT, 2) a sugar content of less than 10 wt %, 3) a total content of at least one of inulin and/or FOS ranging from 2.5-10 wt %, 4) a ratio between saturated to unsaturated fatty acids in total fat content of less than 20/1, and wherein at least one strain of probiotics is evenly distributed in said food product in an oil vehicle and wherein the food product has a probiotic count of at least 10⁶ CFU/kg of dry matter. The invention furthermore relates to methods for obatining the product and production plants for producing the product.

### TECHNICAL FIELD OF THE INVENTION

The present invention relates to human food compositions, methods for obtaining the food compositions and production plants for producing the food compositions. In particular the invention relates to extruded cereal product comprising probiotics for human consumption.

### BACKGROUND OF THE INVENTION

Various commercial attempts have been made to achieve food compositions containing probiotic micro-organisms with prolonged viability for long term storage, many of these do not provide sufficient efficacious levels of viable probiotic micro-organism due to issues associated with susceptibility of the micro-organism to standard commercial food manufacturing procedures such as extrusion. For example, efforts of coating or filling standard pet food kibbles with probiotic microorganisms have been suggested but, in practice, often prove impractical.

WO 01/95745 provides a method of producing a food product (kibbles) characterised by a porous structure, comprising an instable substrate such as a probiotic micro-organism in an oil solution, which are included in a flowable form into the product by means of a step of “partial vacuum” followed by normalizing the pressure by releasing an inert gas into the vessel.

WO 05/070232 provides a method of producing a food product similar to WO 01/95745, further characterized in that the oil should have a solid fat index of at least 20. WO 05/070232 discloses the essential use of fat with the solid fat index of the vehicle is at least 20 at 20° C. and the preferred vehicle are coconut oil and even more preferred palm oil.

WO 03/009710 discloses system and method for on-line mixing and application of surface coating compositions for food products; an apparatus is also disclosed. The apparatus comprises a dry matter—liquid mixing module (wherein the dry matter may be probiotics) connected inline to a liquid—liquid mixing module, wherein one or more liquid can be mixed into the first liquid (potentially comprising the probiotics). Hence, an improved production plant for incorporating probiotics into food products would be advantageous, and in particular a more efficient and/or reliable production plant for incorporating probiotics into food products prolonging the viability of the probiotics would be advantageous.

### SUMMARY OF THE INVENTION

Micro-organisms used as probiotics in a food products are very sensitive to various physical/chemical factors such as temperatures, moist, levels of pH, organic acids etc. Various food manufacturing processes include a heat-treatment, which leads to loss of viability of the probiotic bacteria at the manufacturing stage. Other stages of food product manufacturing include treatment with chemical compounds, serving as an ingredients and/or preservatives, which might have negative effect on the probiotic micro-organism viability. Such treatments of the product shall be allowed only prior to the inclusion of the probiotic micro-organisms, nevertheless any leftovers or defects of the product matrix will have a negative effect on a stability of the product in the future. Therefore it is not recommended to process the food product with probiotic ingredient after the inclusion stage. Ingredients used as a part of the formulation of the ready product should not have a negative influence on probiotic viability. WO 03/009710 teaches away from keeping the suspension comprising the probiotics separate from all other liquids until the reach the solid food product.

To minimize loss of viability of the probiotics during the production stage it may be advantageously to use freeze-dried or any similar way treated probiotic micro-organism.

Another general health problem with food products comprising probiotics is that often sugars are used as a preservative to maintain the viability of the probiotics. Though the viability of the probiotics may be increased the overall health benefits of such products is low at the point regarding the sugar content.

The present invention solves the above problem by disclosing a food product comprising the beneficial effects of a high content of viable probiotics and at the same time having a low content of sugars.

This invention describes extruded ready to eat products for human consumption that includes a fat/oil suspension comprising probiotic micro-organisms, wherein the probiotic compound is vacuum infused throughout the matrix of the product and additionally may be protected by an extra layer of honey or similar compound deriving from natural sources.

Despite the fact that oils/fats that are rich in unsaturated fatty acids are generally considered healthy, these compounds are commonly avoided in food products comprising probiotic micro-organisms. The reason being that these fats are considered to be liquid and less stable therefore not suitable for preserving probiotic micro-organisms for a longer period of time. Surprisingly, it has been found that using the production method of the invention good viability of the probiotics can be maintained in a food product, even when unsaturated fatty acids are present in the disclosed levels.

Thus, in a first aspect the invention relates to a vacuum infused synbiotic extruded food product for humans having;
1) a density of 1 g/L to 1000 g/L at RT,
2) a total sugar content of less than 10 wt %,
3) a total content of at least one of inulin and FOS ranging from 2.5-10 wt %,
4) a ratio of saturated to unsaturated fatty acids in total fat content of less than 20/1, and
   wherein at least one strain of probiotics is evenly distributed in said food product, in an oil vehicle and wherein the food product has a probiotic count of at least 10⁶ CFU/kg of dry matter.

The food product described in this invention should initially be extruded as part of conventional production process since extruded products develop a rigid structure and maintain a porous texture. The density of the vacuum infused products may vary depending on the type of product which has been vacuum infused. Thus, in an embodiment the density is 200 g/L to 1000 g/L, such as 400 g/L to 1000 g/L, such as 600 g/L to 1000 g/L, such as 1 g/L to 500 g/L or such as 100 g/L to 500 g/L.

To sustain the health benefits of the food product described in this invention the final product preferably not include sugar. If the product should not comprise sugar the level in the final food becomes 0%. If the product should comprise sugar the total amount may range from 0.1-10 wt %. Thus, in another embodiment the content of sugar is 0-10%, such as 0.1-8 wt %, such as 0.1-6 wt %, such as 0.1-4 wt %, such as 0.5-4 wt %, or such as 1-4 wt %, or such as 2-3 wt %.

The product may also comprise fructo-oligosaccharides (FOS) and/or inulin at a concentration of not less than 2.5 wt %. Thus, in a further embodiment the content of fructo-oligosaccharides is 2.5-10 wt %, such as 2.5-8 wt %, such as 2.5-6 wt %, such as 2.5-4 wt %, or such as 2.5-3 wt %.

The ratio between saturated to unsaturated fatty acids in total fat content also influences the health benefits of the product. In order to sustain the key health benefits and features of the food product, the product described in this invention may comprise a high level of unsaturated fatty acids. Furthermore, the total amount of fats in the food product may range from 0.5 wt % till 45 wt % of net weight of the product, where preferably the ratio of saturated to unsaturated fats within the total fat content may range from 20/1-1/12. Thus, in yet an embodiment of the invention, the ratio of saturated to unsaturated fatty acids is 20/1 to 1/12, such as 15/1 to 1/10, such as 10/1 to 1/1, such as 5/1 to 1/1, such as 3/1 to 1/1, or such as 1/1.

Known health beneficial unsaturated fatty acids are omega-3 fatty acids such as α-linolenic acid (ALA), eicosapentaenoic acid (EPA), and docosahexaenoic acid (DHA) and omega-6 fatty acids such as linoleic acid and arachidonic acid. Thus in yet an embodiment the unsaturated fatty acids in the product comprises at least one of α-linolenic acid (ALA), eicosapentaenoic acid (EPA), docosahexaenoic acid (DHA), linoleic acid and arachidonic acid.

### BRIEF DESCRIPTION OF THE FIGURES

FIG. 1

FIG. 1 shows one embodiment of the production plant in the present invention in a schematic overview.

FIG. 2

Table 1. Viscosity of selected oil types vs temperature. The viscosity was measured using a rheometer. For further details see Example 1. Delta viscosity between 20° C. and 25° C. is indicated.

FIG. 3

The figure displays the viscosity of selected oil types versus temperature within the temperature interval of 20-25° C. 1: Crude fish oil, 2: Salmon oil A, 4: Cod liver oil, 5: Salmon oil B. For further details see Example 1.

FIG. 4

FIG. 4 shows another embodiment of the production plant in the present invention in a schematic overview.

FIG. 5

FIG. 5 shows the viscosity of selected oil types versus temperature within the temperature interval of 20-25° C.

FIG. 6

FIG. 6 shows the viscosity of selected vegetable oil types versus temperature within the temperature interval of 20-25° C.

FIG. 7

FIG. 7 shows the viscosity of linseed oil versus temperature within the temperature interval of 15-35° C.

FIG. 8

FIG. 8 shows the viscosity of salmon oil A with (susp) or without (raw oil). Suspension comprises probiotics at a concentration/inclusion rate 1.2 kg/ton of final product. Data are shown for a increasing temperature from 5 to 50° C. (arrow pointing to the right) and for a decreasing temperature from 50 to 5° C. (arrow pointing to the left). Exact data points are indicated in FIG. 1 (see also example 6).

The present invention will now be described in more detail in the following.

### DETAILED DESCRIPTION OF THE INVENTION

### Definitions

Prior to discussing the present invention in further details, the following terms and conventions will first be defined:

### Extrusion/Extruded

The terms “extrusion” or “extruded” refer in the present context to “cooking extrusion” which is a combination of heating of food products with the act of extrusion to create a cooked and shaped food product and is a process in which moistened, starchy, proteinaceous foods are cooked and worked into a viscous, plastic-like dough. The results of cooking the food ingredients during extrusion may be: 1) gelatinization of starch, 2) denaturation of protein, 3) inactivation of raw food enzymes, 4) destruction of naturally occurring toxic substances, and 5) diminishing of microbial counts originating from the pre-extruded product. Upon discharge through the die, the hot, plastic extrudate expands rapidly with loss of moisture and heat because of sudden decrease in pressure. After expansion cooling, and drying, the extruded product develops a rigid structure and maintains a porous texture.

### Fat

The term “fat” refers to any edible grade fat or lipid, including fats of avian, animal, plant, or manufactured origin, including, but not limited to, crude or refined fats. Typical animal origin fats include, for example, animal tallow, choice white grease, lard, milk-derived fats such as butter oil, and fat typically contained in cheese. Typical fats of vegetable origin include coconut oil, soybean oil, corn oil, Canola oil, Flaxseed oil, Sunflower oil, Corn oil, Olive oil, Peanut oil, Cottonseed oil, Lard, Palm oil, Butter, tung oil, castor oil, rice bran oil etc. Typical fats of avian origin include fats derived from the tissue of chickens, turkeys, ducks, and geese, for example

The term “liquid fat” refers to fat that is substantially flowable, i.e., liquid. The fat can be liquid at room temperature or rendered substantially flowable by heating the fat until the desired flowability is achieved. Preferably, the fat is substantially flowable at temperatures between about 10° C. to about 90° C.

### Ratio

The term “ratio” as used herein is defined as the weight ratio between two or more substances.

### Weight Percent

As used herein the term “weight percent”, or simply “wt %”, is defined as wt/wt, unless otherwise stated.

### Probiotic

The term “probiotic” as used herein is defined as a live microbial feed supplement which beneficially affects the host by improving its intestinal microbial balance. The probiotic micro-organism may be in a metabolic state of life such a cryptobiosis (e.g. anhydrobiosis) as a consequence of cryopreservation (such as freezing drying). However, the probiotic micro-organism will revert into a metabolic state of life when exposed to an environment enabling the metabolic state of life. Accordingly, a dead organism such as a dead micro-organism does not fall within the definition of a probiotic organism due to the fact that it is not capable of populate and the improving its intestinal microbial balance of the host in question.

Examples of suitable probiotic micro-organisms include yeasts such as Saccharomyces, Debaromyces, Candidaw Pichia and Torulopsis, moulds such as Aspergillus, Rhizopus, Mucor, and Penicillium and Torulopsis

Examples of suitable probiotic micro-organisms include bacteria such as the genera Bifidobacterium, Bacteroides, Clostridium, Fusobacterium, Melissococcus, Propionibacterium, Streptococcus, Enterococcus, Lactococcus, Kocuriaw, Staphylococcus, Peptostrepococcus, Bacillus, Pediococcus, Micrococcus, Leuconostoc, Weissella, Aerococcus, Oenococcus and Lactobacillus. Specific examples of suitable probiotic micro-organisms are: Aspergillus niger, A. oryzae, Bacillus coagulans, B. lentus, B. licheniformis, B. mesentericus, B. pumilus, B. subtilis, B. natto, Bacteroides amylophilus, Bac. capillosus, Bac. ruminocola, Bac. suis, Bifidobacterium adolescentis, B. animalis, B. breve, B. bifidum, B. infantis, B. lactis, B. longum, B. pseudolongum, B. thermophilum, Candida pintolepesii, Clostridium butyricum, Enterococcus cremoris, E. diacetylactis, E. faecium, E. intermedius, E. lactis, E. muntdi, E. thermophilus, Escherichic coli, Kluyveromyces fragilis, Lactobacillus acidophilus, L. alimentarius, L. amylovorus, L. crispatus, L. brevis, L. casei, L. curvatus, L. cellobiosus, L. delbrueckii ss. bulgaricus, L farciminis, L. fermentum, L. gasseri, L. helveticus, L. lactis, L. plantarum, L. johnsonii, L. reuteri, L. rhamnosus, L. sakei, L. salivarius, Leuconostoc mesenteroides, P. cereviseae (damnosus), Pediococcus acidilactici, P pentosaceus, Propionibacterium freuclenreichii, Prop. shertnanii, Saccharontyces cereviseae, Staphylococcus carnosus, Staph. xylosus, Streptococcus infantarius, Strep. Salivarius ss. thermophilus, Strep. thermophilus, Strep. lactis.

### Prebiotic

The term “prebiotic” as used herein is defined as a selectively fermented ingredient by gut microflora that allows specific changes, both in the composition and/or activity in the gastrointestinal microflora that confers benefits upon host well-being and health.” Nonlimiting examples of prebiotics are fructo-oligosaccharides, galacto-oligosaccharides, oligofructose and inulin.

### Synbiotic

The term “symbiotic” as used herein is defined as nutritional supplements combining probiotics and prebiotics to form a synbiotic relationship.

### Monosacharide

The term “monosacharide” as used herein is defined as the basic unit of carbohydrates. They are the simplest form of sugar and are usually colorless, water-soluble, crystalline solids. Some monosaccharides have a sweet taste. Examples of monosaccharides include glucose (dextrose), fructose (levulose), galactose, xylose and ribose. Monosaccharides are the building blocks of disaccharides such as sucrose and polysaccharides.

### Inulin

Inulins are a group of naturally occurring polysaccharides (several simple sugars linked together) produced from many types of plants. They belong to a class of fibers known as fructans.

Inulin is not simply one molecule; it is a polydisperse β (2-1) fructan. The fructose units in this mixture of linear fructose polymers and oligomers are each linked by β (2-1) glycosidic bonds. A glucose molecule typically resides at the end of each fructose chain and is linked by an a (1-2) bond, as in sucrose. The chain lengths of these fructans range from 2 to 60 units, with an average degree of polymerization (DP) of ˜10.

The unique aspect of the structure of inulin is its β (2-1) bonds. These linkages prevent inulin from being digested like a typical carbohydrate and are responsible for its reduced caloric value and dietary fiber effects.

Inulin and fructo-oligosaccharides are present as plant storage carbohydrates in a number of vegetables and plants including wheat, onion, bananas, garlic and chicory. Plant inulins generally contain between 20 to several thousand fructose units. Smaller compounds are called fructo-oligosaccharides.

Inulin and fructo-oligosaccharides act as a prebiotic and have a minimal impact on blood sugar. For example the root of the Cichorium intybus plant contains ˜15-20% inulin and 5-10% fructo-oligosaccharides.

### Sugar

Sugar is a class of edible crystalline substances, mainly sucrose, lactose, and fructose. Human taste buds interpret its flavor as sweet. Sugar refers to any monosaccharide or disaccharide

### Oligosaccharide

An oligosaccharide is a saccharide polymer containing a small number (typically three to ten) of component sugars, also known as simple sugars. In the present context polysaccharides can also be considered as oligosaccharides.

### Polysaccharide

The term “polysaccharide” as used herein is defined as polymers made up of many monosaccharides joined together by glycosidic bonds. They are therefore very large, often branched, macromolecules. Examples include storage polysaccharides such as starch and glycogen and structural polysaccharides such as cellulose and chitin. Another example is fructo-oligosaccharides (FOS). Polysaccharides have a general formula of Cₓ(H₂O)_{y} where x is usually a large number between 200 and 2500. Considering that the repeating units in the polymer backbone are often six-carbon monosaccharides, the general formula can also be represented as (C₆H₁₀O₅)n where n={40 . . . 3000}. Oligosaccharides are considered as prebiotics.

### Glycemic Index

The Glycemic index (also glycaemic index) or GI is a measure of the effects of carbohydrates on blood glucose levels. Carbohydrates that break down rapidly during digestion releasing glucose rapidly into the bloodstream have a high GI; carbohydrates that break down slowly, releasing glucose gradually into the bloodstream, have a low GI. Foods with a low GI have significant health benefits, especially for people with diabetes.

A lower glycemic index suggests slower rates of digestion and absorption of the foods' carbohydrates and may also indicate greater extraction from the liver and periphery of the products of carbohydrate digestion.

The current validated methods use glucose as the reference food, giving it a glycemic index value of 100 by definition.

GI values can be interpreted intuitively as percentages on an absolute scale and are commonly interpreted as follows: Low GI (55 or less)—most fruit and vegetables (except potatoes, watermelon), grainy breads, pasta, legumes/pulses, milk, products extremely low in carbohydrates (fish, eggs, meat, nuts, oils), brown rice.

Medium GI (56-69)—whole wheat products, basmati rice, sweet potato, table sugar, most white rice (e.g., jasmine).

High GI (70 and above)—corn flakes, baked potato, watermelon, croissant, white bread, extruded cereals (e.g., Rice Krispies), straight glucose (100).

### Viscosity

The term “viscosity” refers a measure of the resistance of a fluid which is being deformed by either shear stress or extensional stress. In everyday terms (and for fluids only), viscosity is “thickness”. The coefficient of viscosity is most often used as a value for viscosity. The shear viscosity and dynamic viscosity are most frequently used. “Dynamic viscosity” (or absolute viscosity) is a unit of measuring viscosity. The SI physical unit of dynamic viscosity is the pascal-second (Pa·s), which is identical to kg·m⁻¹·s⁻¹. If a fluid with a viscosity of one Pa·s is placed between two plates, and one plate is pushed sideways with a shear stress of one pascal, it moves a distance equal to the thickness of the layer between the plates in one second. The cgs physical unit for dynamic viscosity is the poise. It is more commonly expressed, particularly in ASTM standards, as centipoise (cP). The relation between poise and pascal-seconds is: 1 cP=0.001 Pa·s=1 mPa·s. Water at 20° C. has a viscosity of 1.0020 cP. Dynamic viscosity is measured with various types of rheometer, for example Physica MCR 301 as used in Example 1. The temperature dependence of the viscosity of the fluid is the phenomenon by which fluid viscosity generally decrease (or, alternatively, its fluidity generally increases) as its temperature increases. Thus, close temperature control of the fluid is essential to accurate measurements, particularly in materials like lubricants, whose viscosity can double with a change of only 5° C. The dynamic viscosity referred to in the context of the present invention is the dynamic viscosity at 20° C. if noting else is stated. In the context of the present invention the change in dynamic viscosity of an oil is expressed as Δ Pa·s/° C. Alternatively, the change in dynamic viscosity of an oil is described as the difference between the dynamic viscosity at 25° C. and 20° C. (Pa·s at 25° C.−Pa·s at 20° C.=Δ Pa·s).

### Peroxide Value

The best test for autoxidation (oxidative rancidity) is determination of the “peroxide value”. Peroxides are intermediates in the auto oxidation reaction.

The number of peroxides present in edible fats and oils is an index of their primary oxidative level and consequently of its tendency to go rancid. The lower is the peroxide value, the better is fat or oil quality and its status of preservation. Other methods are available but peroxide value is the most widely used. The double bonds found in fats and oils play a role in auto oxidation. Oils with a high degree of unsaturation are most susceptible to auto oxidation. Auto oxidation is a free radical reaction involving oxygen that leads to deterioration of fats and oils which form off-flavours and off-odours. Peroxide value, concentration of peroxide in an oil or fat, is useful for assessing the extent to which spoilage has advanced.

The peroxide value is defined as the amount of peroxide oxygen per 1 kilogram of fat or oil. Typically this is expressed in units of milliequivalents (mequiv or meq). If SI units are used the appropriate unit is millimoles per kilogram (N.B. 1 millimole=2 milliequivalents).

The peroxide value of the oil also affects the preservation of the probiotic organism for which the oil is used as vehicle in the vacuum inclusion of the probiotic organism in an extruded food product. An oil with a low peroxide value is preferred as vehicle due to the better probiotic preservative properties over an oil with a higher peroxide value.

### Density

The term “density” of a material is defined as its mass per unit volume (g/L).

### Colony-Forming Unit (CFU)

The term “colony-forming unit (CFU)” is a measure of viable bacterial or fungal numbers. Unlike in direct microscopic counts where all cells, dead and living, are counted, CFU measures viable cells. CFU is typically given in CFU per unit of the matter comprising the CFU. Thus, CFU is typically given in CFU/l or CFU/g of matter comprising the colony-forming unit. The CFU of a matter is typically assessed by suspending a known amount of the matter in a suitable liquid. The liquid may subsequently be subjected to further dilution, which is used for inoculation in a suitable growth media such as plates of clear nutrient agar or a suitable alternative.

### Omega-3 Fatty Acids

The term “omega-3 fatty acids” are a family of unsaturated fatty acids that have in common a final carbon-carbon double bond in the n-3 position; that is, the third bond from the methyl end of the fatty acid. Examples of important nutritionally essential omega-3 fatty acids are α-linolenic acid (ALA), eicosapentaenoic acid (EPA), and docosahexaenoic acid (DHA).

### Omega-6 Fatty Acids

The term “omega-6 fatty acids” are a family of unsaturated fatty acids which have in common a final carbon-carbon double bond in the n-6 position; that is, the sixth bond from the end of the fatty acid. Examples of omega-6 fatty acids are linoleic acid and arachidonic acid.

### Oil

In the context of the present invention the term “oil” refers to any edible vegetable and animal oils. Oil in the context of the present invention is in a viscous liquid state (“oily”) at room temperature. Oil includes “fatty acids”, which are carboxylic acids often with a long un-branched aliphatic tail (chain), which is either saturated or unsaturated (such as monounsaturated or polyunsaturated). The ratio of saturated to unsaturated fatty acids varies among oils. For example, flaxseed oil comprises 9% of saturated fatty acids, 18% mono-unsaturated fatty acids, and 73% of polyunsaturated fatty acids. In contrast, coconut oil comprise 91% saturated fatty acids, 7% mono-unsaturated fatty acids, and 2% poly-unsaturated fatty acids. For dietary application oils which are rich in unsaturated fatty acids are highly preferred due to the health benefits of the unsaturated fatty acids over the saturated fatty acids. Thus, in order to sustain the key health benefits and features of the food product, the product described in this invention shall comprise a high level of unsaturated fatty acids. Fish oils fall within the definition of oil. Fish oils include but are not limited to salmon oil, mackerel oil, lake trout oil, herring oil, sardine oil, albacore tuna oil, cod liver oil, sand eel oil (Ammodytes tobianus), and menhaden oil.

### Vehicle

The term “vehicle” refers to a fluid component (such as an oil) that carries at least one substance. In the context of the present invention an oil is used a vehicle for vacuum infusion of at least one probiotic micro-organism into an extruded food product. The vehicle may have the additional function of preserving the at least one probiotic micro-organism embedded in the extruded food product. It is to be understood that an oil vehicle is also a suspension comprising probiotics. It is to be understood that a suspension may also be a vehicle.

Accordingly, at least one oil used by the present invention functions as vehicle for infusion of probiotic micro-organisms in the manufacturing of an extruded food product. The manufacturing is performed at room temperature in order to optimize the probiotic count (CFU) in the final food product. In this respect the viscosity properties of the oil (e.g. dynamic viscosity) influence whether or not the oil is suitable for the vacuum infusion of the food product. Oils having an optimal viscosity at a temperature above room temperature may not be applicable at room temperature due to the change in viscosity.

### Preservative

The term “preservative” refers to a natural or synthetic substance that is added to the food product to preserve the product. “probiotic preservative” refers to a substance that preserves the probiotic organism in the sense of the ability of the organism to establish and populate the gastro-intestinal system of the host (e.g. a human being or an animal such as a pet animal). The preservation is reflected in the colony-forming unit (CFU) of the final food product and/or the sustained CFU of the final food product over time of storage.

### Antioxidant

The term “antioxidant” refers to a substance capable of slowing or preventing the oxidation of other substances. Antioxidants are frequently used as food additives to reduce food deterioration. Both synthetic and natural antioxidants are used. Natural antioxidants have been identified among a wide range of classes of compounds such as flavanoids, cartonoids, tocotrienol, tocopherol and terpenes (such as astaxanthin). In one embodiment of the invention the synthetic antioxidant is selected from the group consisting of butylated hydroxyanisole (BHA) and butylated hydroxytoluene (BHT) and natural antioxidant is selected from the group consisting of Vitamin E flavonoids, and polyphenolics. The natural antioxidant may be provided in the form of an extract for example rosemary or grape seed extracts (comprising resveratrol).

### Water Activity (A_{w})

The term “Water activity (A_{w})” reflects the active part of moisture content or the part which, under normal circumstances, can be exchanged between the product and its environment. The active part of moisture content and, therefore, water activity, provide better information than the total moisture content regarding the micro-biological, chemical and enzymatic stability of perishable products such as foods and seeds. Water activity can be difined as:

A_{w}=p/ps

and

% ERH=100×Aw

In these equations “p” is the partial pressure of water vapor at the surface of the product, “_{Ps}” is the saturation pressure, or the partial pressure of water vapor above pure water at the product temperature and “% ERH” is the equilibrium relative humidity.

### Food Product

The term “food product” as used herein refers to any food product to which the beneficial function of probiotics is wished to be added. For example, it may be a breakfast cereals, pet food, treats. However, it may be any food, intended for any humans and/or animals. For example, the food product may be a particulate food or food ingredient, such as extruded snack products, tortilla chips, breakfast cereal, cookies, crisp bread, food foams, Rice brokens, blend of peanut, soybean and corn, puffed wheat, low density foamed corn and rice breakfast, Co-extruded products, muesli bars and any other extruded products that are formed by extrusion process.

### Suspension

The term “suspension” refers to a fluid (such as an oil) containing particles that will not dissolve in the fluid and are sufficiently large for sedimentation such as freeze dried micro-organisms. A homogenous suspension refers to a suspension, wherein the particles are dispersed throughout the external phase (the fluid) through mechanical agitation (such as mixing). The suspended particles (e.g. micro-organisms) are visible under a microscope and will settle over time if left undisturbed. It is to be understood that an oil vehicle is also a suspension comprising probiotics.

### Room Temperature

The term “room temperature” (also referred to as ambient temperature) is denoting the temperature within enclosed space at which humans are accustomed. The room temperature (RT) in the context of the present invention is defined by the range of 15° C. to 29° C.

### Fructo-Oligosaccharides

The term “fructo-oligosaccharides” (FOS) also sometimes called oligofructose or oligofructan, refers to a class of oligosaccharides used as alternative sweeteners. Natural sources of FOS are e.g. extractions from fruits and vegetables like bananas, onions, chicory root, garlic, asparagus, barley, wheat, jícama, tomatoes, leeks, the Jerusalem artichoke and yacón. FOS can also be produced based on inulin degradation or transfructosylation processes. FOS are considered as prebiotics.

### Vacuum Infusion

The term “vacuum infusion” refers to inclusion of a substance through out an object by means on vacuum. On limiting examples of vacuum infusion are infusion of a suspension (comprising a vehicle and at least one probiotic micro-organism) in a of porous food matrices such as an extruded food product.

In the following sections the inventions will be discussed in further detail.

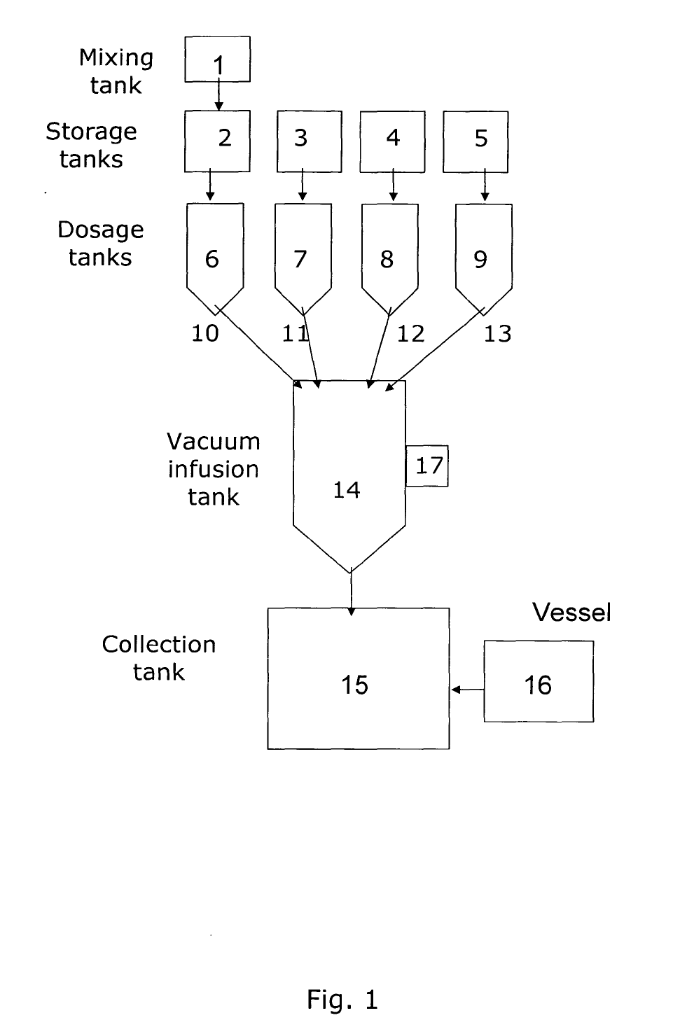

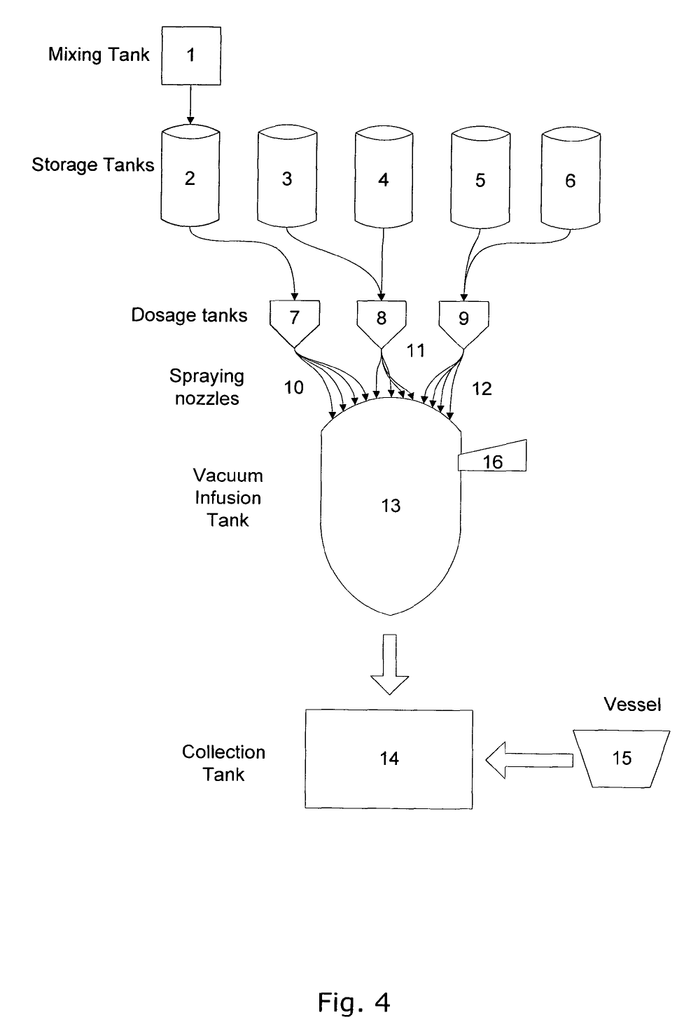

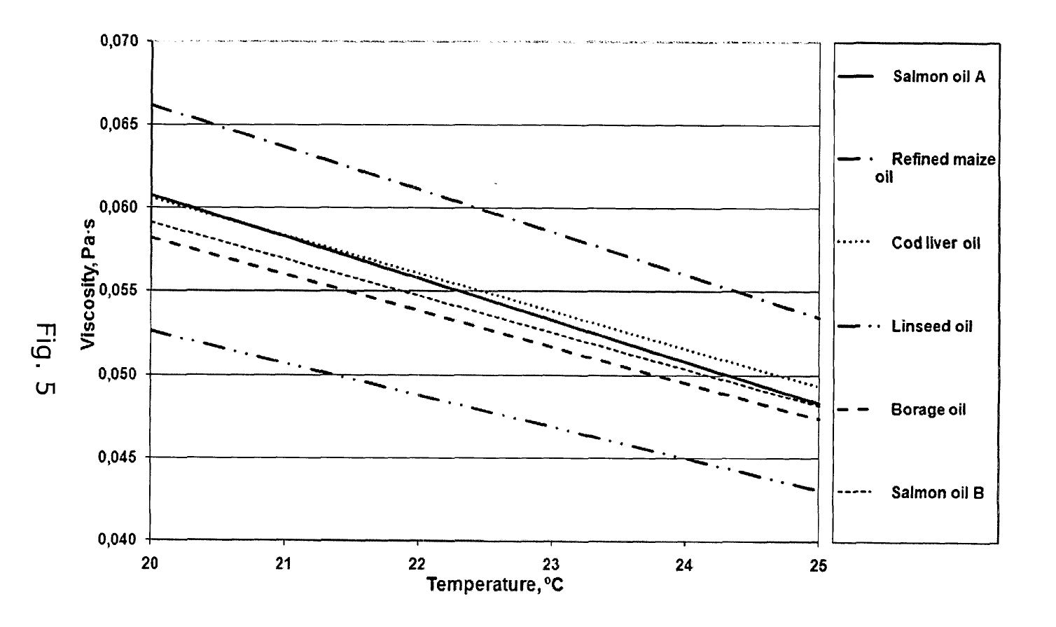

### Comments To FIGS. 1 And 4

FIGS. 1 and 4 show two alternative embodiments of the invention illustrating tanks, vessels connections and the like which may form part of the production plant according to the invention. Numbering without reference signs refer to FIG. 4 whereas numbering with reference signs refer to FIG. 1. The person skilled in the art would easily be able to convert any numbering differing between FIGS. 1 and 4.

The plant may comprise one or more storage tanks 2-6 (2-5) which can be used to store individual solutions, such as a probiotic suspension, a solution of fat. The storage tank 2 (2) may be further connected to a mixing tank 1 (1). The reason is that mixing of an oil/fat suspension with a freeze dried probiotic powder, may result in precipitation of the probiotics if the powder is not mixed slowly into to oil/fat suspension. This mixing may be performed manually. The mixing tank 1 (1) may be physically positioned above the storage tank 2. In this way the suspension in the mixing tank 1 (1) may be transferred to the storage tank 2 through an outlet positioned at the bottom of mixing tank 1 (1). Furthermore, this setup means that the transfer can be performed only by the force of gravity, which may be beneficial for the viability of the probiotics in the suspension.

The storage tank 2 (2) and the dosage unit tank 7 (6) for storing and dosing a probiotic suspension may comprise means for mixing the suspension such as an impeller or a rotational tank or a combination of both. The other storage and dosage tanks may comprise similar means for mixing. Each of the storage tanks 2-6 (2-5) may then be further connected to individual dosage tanks 7-9 (6-9). Each of the dosage tanks 7-9 (6-9) may then be further connected to a single vacuum infusion tank 13 (14). These connections are in one embodiment spraying nozzles 10-12 (10-13) connecting each dosage tank individually to the vacuum infusion tank 13 (14), allowing for spraying the content of each of the dosage unit tanks individually on the food products present in the vacuum infusion tank 13 (14). This is important to avoid mixing of the oil/fat suspension comprising probiotics with one or more of the other solutions, since intermixing may lower the viability of the probiotics. Thus, at least the spraying nozzles leading from the probiotic-oil/fat suspension to the vacuum infusion tank should not be connected to any of the other dosage tanks.

The precise shape of the spraying nozzles may vary, since the form and shape of the nozzles have to be optimized to the solution/suspension which is going to be sprayed through the nozzles.

The vacuum infusion tank may furthermore comprise one or more openings 16 (17) for receiving a food product. When the food product is in place in the tank the following steps may take place:
a) reduction of the pressure in the vacuum infusion tank to 0.2-0.95 bar,
b) vaporization of one of the solutions from one of the dosage unit tanks 6-9 through the corresponding one or more spraying nozzles 10-12 at e.g. a temperature of 15-30° C.,
c) restore pressure to 1 bar,

Steps a)-c) may then be repeated with other solutions (or the same solution) to further vacuum infusions into the food product. This is important for getting the subsequent solutions infused into the product. The release of the vacuum may be performed slowly to avoid abrupt changes in pressure which may be harmful to the product and/or the probiotics.

Some vacuum tanks are designed to release the pressure in the vacuum tank using an inert gas, which may actually be harmful for the viability of the probiotics and/or organoleptic/chemical parameters of the suspension. Organoleptic refers to any sensory properties of a product, involving taste, colour, odour and feel. Thus, in an embodiment the pressure release is not performed with an inert gas such as nitrogen and carbondioxide. It is to be understood that release of the pressure using atmospheric air is part of the invention though atmospheric air comprises nitrogen and carbondioxide.

To get the sprayed solutions evenly distributed in the infusion tank some kind of mixing may be required. Thus the mixing tank may be able to rotate or comprise an impeller or the like. Therefore it may be advantageously if the mixing is performed during the spraying steps or after each of the spraying steps.

The vacuum infusion tank may also comprise an outlet leading to a collection vessel 15 (16). The collection tank 14 (15) may be particular useful, when a coating is also required on the food product (which is not going to be vacuum infused). Such a coating may be stored in a vessel 15 (16) connected to the collection tank 14 (15). Examples of coatings could be solutions comprising honey, natural sweeteners, artificial sweeteners, vitamins, tartar or other additives or the like. For example, the product may comprise or be covered with Raw honey, Barely malt, brown rice syrup, Agave syrup, Apple syrup, Stevia, evaporated fruit juices (Cherries, Grapefruit, Dried apricots, Pear, Apple, Plum, Peach, Orange, Grapes), unsulphured molasses, evaporated cane juice and grape juice concentrate.

### Human Food Product

### Food Product

It would be advantageously to have a food product comprising probiotics with a high viability even after long storage periods. It would be an additional advantage to have a healthy food product which comprises a high amount of living probiotics. Thus, in a first aspect the invention relates to a vacuum infused synbiotic extruded food product for humans having;
1) a density of 1 g/L to 1000 g/L at RT,
2) a sugar content of less than 10 wt %,
3) a total content of at least one of inulin and FOS ranging from 2.5-10 wt %,
4) a ratio of saturated to unsaturated fatty acids in total fat content of less than 20/1, and
   wherein at least one strain of probiotics is evenly distributed in said food product in an oil vehicle and wherein the food product has a probiotic count of at least 10⁶ CFU/kg of dry matter.

The food product described in this invention should initially be extruded as part of conventional production process since extruded products develop a rigid structure and maintains a porous texture. The density of the vacuum infused products may vary depending on the type of product which has been vacuum infused. Thus, in an embodiment the density is 200 g/L to 1000 g/L, such as 400 g/L to 1000 g/L, such as 600 g/L to 1000 g/L, such as 1 g/L to 500 g/L or such as 100 g/L to 500 g/L.

To sustain the health benefits of the food product described in this invention the final product may or may not include sugar. If the product should not contain sugar, the level in the final food becomes 0 wt %. If the product should contain sugar, the total amount may range from 0.1-10 wt %. Thus, in another embodiment the content of sugar is 0-10 wt %, such as 0.1-8 wt %, such as 0.1-6 wt %, such as 0.1-4 wt %, such as 0.5-4 wt %, or such as 1-4 wt %.

The sugar may be monosaccharides. Thus, in another embodiment the content of monosaccharides is 0-10 wt %, such as 0.1-8 wt %, such as 0.1-6 wt %, such as 0.1-4 wt %, such as 0.5-4 wt %, or such as 1-4 wt %.

The sugar may also be disaccharides. Thus, in another embodiment the content of disaccharides is 0-10 wt %, such as 0.1-8 wt %, such as 0.1-6 wt %, such as 0.1-4 wt %, such as 0.5-4 wt %, or such as 1-4 wt %.

The product may also comprise at least one of fructo-oligosaccharides and/or inulin at a concentration of at least 2.5 wt %. Thus, in a further embodiment the content of fructo-oligosaccharides is 2.5-10 wt %, such as 2.5-8 wt %, such as 2.5-6 wt %, such as 2.5-4 wt %, or such as 2.5-3 wt %.

In yet a further embodiment the content of inulin is 2.5-10 wt %, such as 2.5-8 wt %, such as 2.5-6 wt %, such as 2.5-4 wt %, or such as 2.5-3 wt %.

In another embodiment a total content of at least one of inulin and FOS ranging from 2.5-10 wt %, such as 2.5-8 wt %, such as 2.5-6 wt %, such as 2.5-4 wt %, or such as 2.5-3 wt %. By the term “a total content”, it is to be understood as the combined concentration of inulin and FOS.

The ratio between saturated to unsaturated fatty acids in total fat content also influences the health benefits of the product. In order to sustain the key health benefits and features of the food product, the product described in this invention shall comprise a high level of unsaturated fatty acids. Furthermore, the total amount of fats in the food product may range 0.5% till 45% of net weight of the product, where preferably the ratio between saturated to unsaturated fats within the total fat content shall range 20/1-1/12. Thus, in yet an embodiment of the invention, the ratio between saturated to unsaturated fatty acids is 20/1 to 1/1, such as 15/1 to 1/1, such as 10/1 to 1/1, such as 5/1 to 1/1, such as 1/1 to 1/1 such as 1/1 to 1/4 such as 1/1 to 1/8, or such as 1/1 to 1/12. Known health beneficial unsaturated fatty acids are omega-3 fatty acids such as α-linolenic acid (ALA), eicosapentaenoic acid (EPA), and docosahexaenoic acid (DHA) and omega-6 fatty acids such as linoleic acid and arachidonic acid. Thus in yet an embodiment the unsaturated fatty acids in the product comprises at least one of α-linolenic acid (ALA), eicosapentaenoic acid (EPA), docosahexaenoic acid (DHA), linoleic acid and arachidonic acid.

### Food Product Variations

The food products of the invention may origin from different sources. Thus, in an embodiment of the invention, the product is selected from the group consisting of extruded snack products, tortilla chips, breakfast cereals, cookies, crisp bread, food foams, rice brokens, blend of peanut, soybean and corn, puffed wheat, low density foamed corn and rice breakfast, co-extruded products, muesli bars and any other extruded food products that are formed by extrusion process.

An advantage of using extruded food products is that upon discharge through the die, the hot, plastic extrudate expands rapidly with loss of moisture and heat because of sudden decrease in pressure. After expansion cooling, and drying, the extruded product develops a rigid structure and maintains a porous texture. The porous texture makes the oil/fat vehicle enter more easily into the product during the vacuum infusion.

### Proviso For Synthetic Sweeteners

It may be disadvantageously to use synthetic sweeteners in the product of the invention, since they may be provide a health risk. Thus, in a further embodiment the food product does not comprise a synthetic sweetener.

### Probiotic Count

A certain amount of probiotics need to be viable in the product following manufacturing. Thus, in an embodiment the count of at least one probiotic in the food product is 10⁶-10¹⁹ CFU/kg, such as 10⁶-10¹⁶, such as 10⁶-10¹², such as 10⁷-10¹⁴, such as 10⁷-10¹², such as 10⁷-10¹⁰, or such as 10⁸-10¹⁰ CFU/kg. By having a food product with a CFU as described above, beneficial effects can be achieved for person eating the product.

### Glycemic Index

The glycemix index of the product may be important for having an attractive nutritional value. Thus in a further embodiment the food product of the invention has a glycemic index of 1-55, such as 10-55, such as 20-55, such as 30-55, such as 20-40, or such as 10-30. Foods with a low GI have significant health benefits, especially for people with diabetes.

### Stability of the Product

As used herein, the term “shelf life” refers to that property of the products of the invention whereby about 1% or more, alternatively about 5% or more, alternatively about 10% or more, alternatively about 25% or more, alternatively about 50% or more, alternatively about 75% or more, of the probiotic microorganisms are viable (see also definitions of CFU) at the referenced time period after exposure to ambient environmental conditions. The shelf life of the products of the invention is 6-36 month, such as 6-24 month, such as 9-20 month, and such as 12-16 month.

### Shelf-Life

The probiotic comprising products of the invention may have a superior shelf-life. Thus, in an embodiment of the invention the count of at least one probiotic in the food product is 10⁶-10¹⁹ CFU/kg, such as 10⁶-10¹⁶, such as 10⁷-10¹⁶, such as 10⁷-10¹⁴, such as 10⁷-10¹², such as 10⁷-10¹⁰, or such as 10⁸-10¹⁰ CFU/kg after at least 3 month after the date of manufacturing.

In another embodiment of the invention the count of at least one probiotic in the food product is 10⁶-10¹⁹ CFU/kg, such as 10⁶-10¹⁶, such as 10⁷-10¹⁶, such as 10⁷-10¹⁴, such as 10⁷-10¹², such as 10⁷-10¹⁰, or such as 10⁸-10¹⁰ CFU/kg after at least 6 month after the date of manufacturing.

In a further embodiment of the invention the count of at least one probiotic in the food product is 10⁶-10¹⁹ CFU/kg, such as 10⁶-10¹⁶, such as 10⁷-10¹⁶, such as 10⁷-10¹⁴, such as 10⁷-10¹², such as 10⁷-10¹⁰, or such as 10⁸-10¹⁰ CFU/kg at least 10 month after the date of manufacturing.

In yet a further embodiment of the invention the count of at least one probiotic in the food product is 10⁶-10¹⁹ CFU/kg, such as 10⁶-10¹⁶, such as 10⁷-10¹⁶, such as 10⁷-10¹⁴,such as 10⁷-10¹², such as 10⁷-10¹⁰, or such as 10⁸-10¹⁰ CFU/kg after at least 15 month after the date of manufacturing.

In an additional embodiment of the invention the count of at least one probiotic in the food product is 10⁶-10¹⁹ CFU/kg, such as 10⁶-10¹⁶, such as 10⁷-10¹⁶, such as 10⁷-10¹⁴,such as 10⁷-10¹², such as 10⁷-10¹⁰, or such as 10⁸-10¹⁰ CFU/kg after at least 20 month after the date of manufacturing.

It is to be understood that these counts may be achieved following standard storing conditions (shelf-life) known to the person skilled in the art.

### Taste And Odour

It may be important that the food product of the invention has an appealing taste and odour. Thus, in yet an embodiment the oil vehicle is tasteless and odourless. In an additional embodiment the oil is a vegetable oil selected from the group consisting of linseed oil, olive oil, borage oil, lin oil, camelina oil, grape seed oil, chia oil, kiwifruit seeds oil, perilla oil, lingonberry, purslane oil, seabuckthorn oil, hemp oil. In yet an embodiment the oil is linseed oil.

### Oil

It is important for the viability of the probiotics in the oil vehicle that the oil provides preservative effects.

Thus, in an embodiment the oil is a fish oil. In a further embodiment the oil is selected from the group consisting of salmon oil, mackerel oil, lake trout oil, herring oil, sardine oil, albacore tuna oil, sand eel oil, Ammodytes tobianus oil, and menhaden oil, coconut oil, soybean oil, corn oil, Canola oil, Flaxseed oil, Sunflower oil, Corn oil, Olive oil, Peanut oil, Cottonseed oil, Lard, Palm oil, Butter, tung oil, castor oil, rice bran oil and linseed oil. Oils have been found to have preservative effects towards probiotics.

### Suspension

It is to be understood that an oil vehicle is also a suspension comprising probiotics.

One aspect of the present invention relates a suspension for vacuum infusion of an extruded food product, wherein said suspension comprises an oil/fat and at least one probiotic micro-organism in the concentration of 10⁷-10¹⁷ CFU/kg of said oil and said suspension having a dynamic viscosity of less than 0.08 pascal-second (Pa·s) at 20° C. The suspension is used in the preparation of an extruded food product and serves as a mean of obtaining a probiotic food extruded product characterized by homogenously distribution of the probiotic micro-organisms throughout the porous matrices of the food product. In order accomplish this object, the substances for the preparation of the suspension should be carefully selected. The suspension in the final form ready for use in the manufacturing of the probiotic food extruded product should enable an efficient vacuum infusion process without interfering with the manufacturing process such as clotting various parts of the apparatus used in the manufacturing. For example, the inventors have experienced that the use of probiotic/oil suspension may clot the fluidic system e.g. by clotting the nozzle used for spraying the suspension on the product in a vacuum infusion tank. The accumulation of matter from the suspension in the system leading to clotting; such clotting of the spraying nozzle may results in premature termination of the production in order to clean and eventually repair the line of production. One key parameter is the viscosity of the probiotic oil suspension for the vacuum infusion process. In their effort to avoid the very unfortunate terminations of the production of the manufacturing of the probiotic food extruded product, the inventors discovered the importance of the viscosity of the oil used as vehicle in the suspension. Further, the inventors discovered that although the oil may be suitable as such for vacuum infusion, the physical properties of the probiotic/oil suspension based on the oil may be different and the suspension may not be suitable for the vacuum infusion process due to a suboptimal viscosity.

The probiotic/oil suspension of the invention comprises at least one oil/fat and at least one probiotic organism. In one embodiment, the suspension comprises additionally at least one additive. The present invention provides a suspension comprising at least one oil/fat and at least one probiotic organism for application in a vacuum having a dynamic viscosity of less than 0.08 pascal-second (Pa·s) at 20° C.

In an alternative aspect the invention relates to a suspension for vacuum infusion of an extruded probiotic food product, wherein said suspension comprises an oil and at least one probiotic micro-organism in the concentration of 10⁶-10¹⁶ CFU/kg of said oil, and wherein said oil having a dynamic viscosity of less than 0.08 pascal-second (Pa·s) at 20° C.

### Dynamic Viscosity of the Vehicle Oil/Fat

The oil/fat component of the suspension serves the purpose of a vehicle. In one embodiment of the invention, the oil/fat of the suspension has a dynamic viscosity of less than 0.08 pascal-second (Pa·s) at 20° C., such as less than 0.075 pascal-second (Pa·s) at 20° C., for example less than 0.070 pascal-second (Pa·s) at 20° C., such as less than 0.065 pascal-second (Pa·s) at 20° C., for example less than 0.060 pascal-second (Pa·s) at 20° C., such as less than 0.055 pascal-second (Pa·s) at 20° C., for example less than 0.050 pascal-second (Pa·s) at 20° C., such as less than 0.045 pascal-second (Pa·s) at 20° C., for example less than 0.040 pascal-second (Pa·s) at 20° C. In one embodiment, the dynamic viscosity of the vehicle oil is less than 0.060 pascal-second (Pa·s) at 20° C. In a further, embodiment, the dynamic viscosity of the vehicle oil within the range of 0.050 to 0.07 pascal-second (Pa·s) at 20° C., such as the range of 0.053 to 0.066 pascal-second (Pa·s) at 20° C.

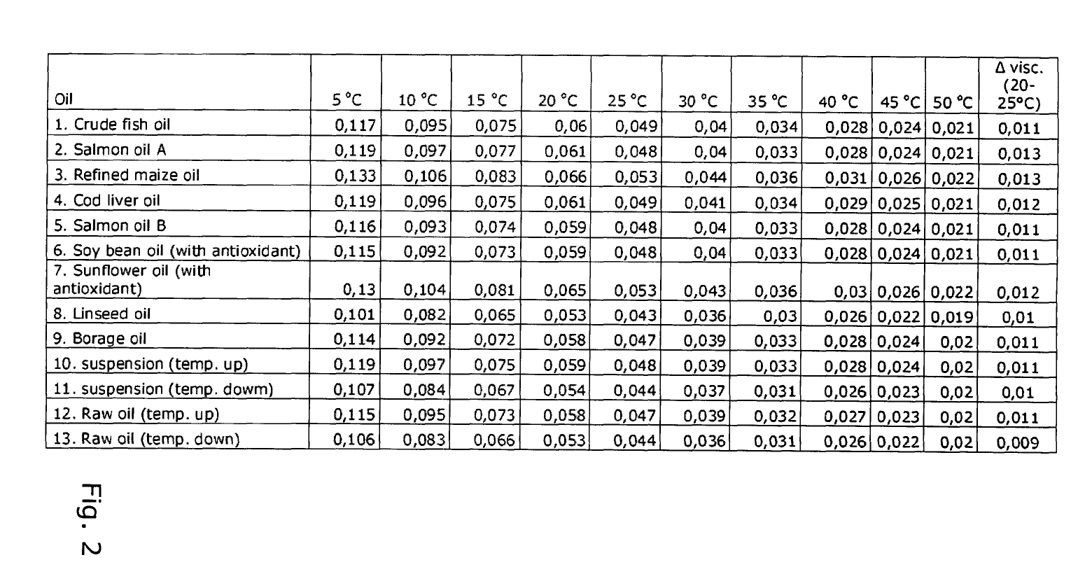

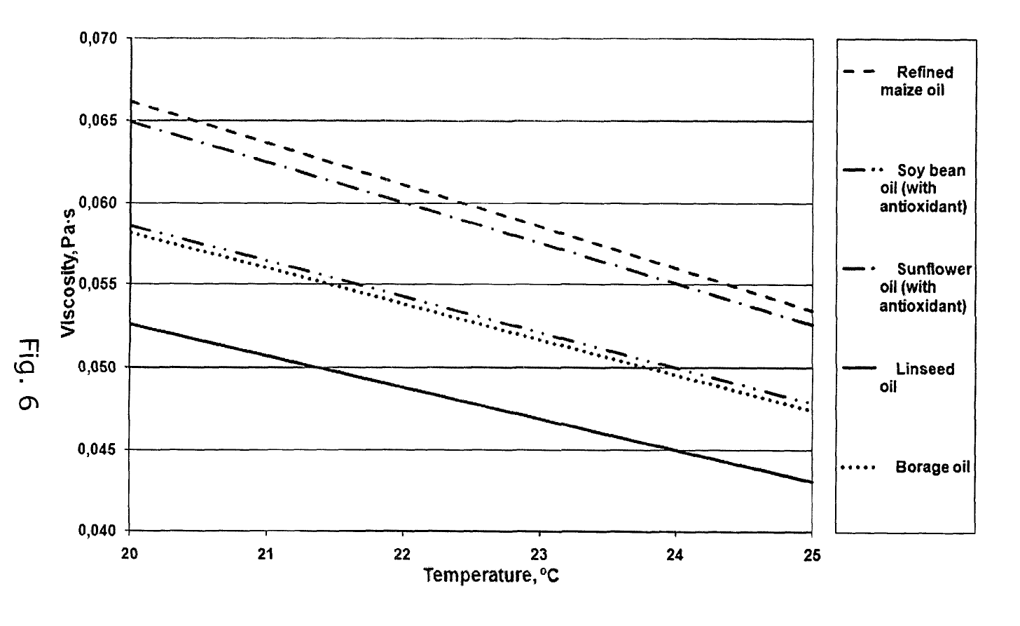

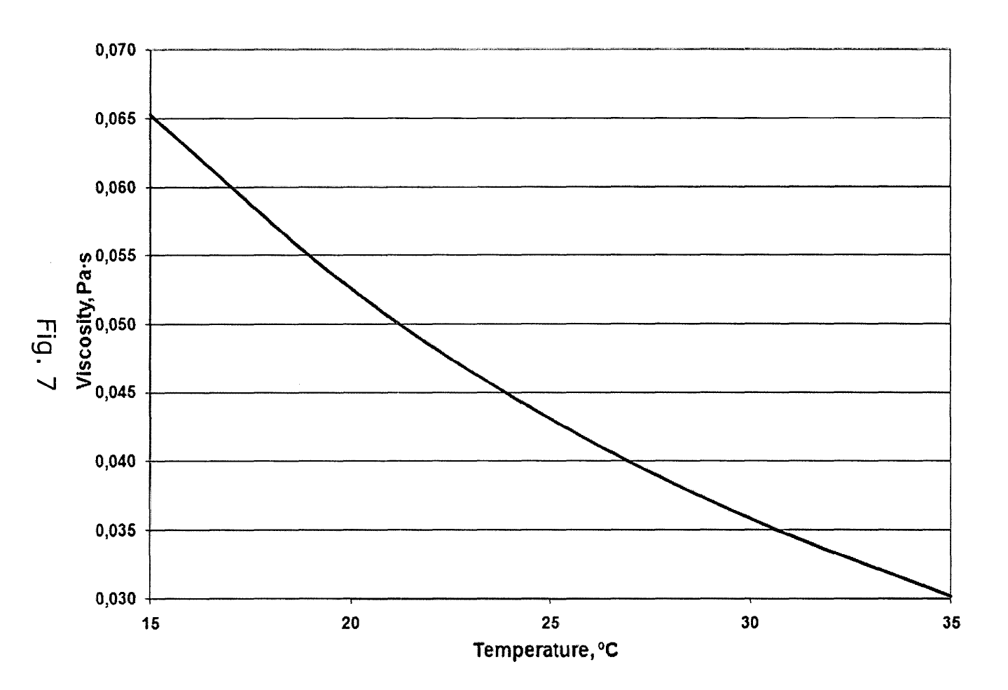

An example of an oil having a viscosity at 20° C. of less than 0.060 pascal-second (Pa·s) is linseed oil (Vobra Special Petfoods BV, Netherlands) (see FIGS. 2 and 6).

Δ Pa·s of the oil vehicle between 20° C. and 25° C.

The change in viscosity of the oil vehicle between 20° C. and 25° C. may be an important feature of the oil vehicle. Thus, in an embodiment according to the invention the Δ Pa·s between 20° C. and 25° C. of the oil vehicle is at least 0.009, such as such as in the range 0.009-0.05 Pa·s, such as in the range 0.01-0.05 Pa·s, such as 0.01-0.04 Pa·s, such as 0.013-0.020 Pa·s, such as in the range 0.013-0.018 Pa·s such as in the range 0.013-0.016 Pa·s. An example of an oil in these intervals is salmon oil A (see FIG. 2).

In the present context delta viscosity (Δ Pa·s) is calculated by subtracting the viscosity at 20° C. from the viscosity at 25° C. Viscosity of oils is calculated using the method disclosed in example 1.

In an additional embodiment the oil vehicle has either a dynamic viscosity of less than 0.08 Pa·s or a Δ Pa·s of the oil vehicle between 25° C. and 20° C. of at least 0.009 Pa·s. Examples of such oils are salmon oil A and linseed oil (see FIG. 2).

In yet an embodiment the oil vehicle has a dynamic viscosity of less than 0.08 Pa·s and a Δ Pa·s of the oil vehicle between 25° C. and 20° C. in the range 0.009-0.05 Pa·s. An example of such an oil is salmon oil A (see FIG. 2).

It is to be understood that the intervals provided for the dynamic viscosity and the delta viscosity of the oil vehicles according to the invention also apply to the embodiments relating to the combination of the two embodiments and the embodiments which relate to an alternatives between the two embodiments.

### Classes of Oils

The oil may be any edible vegetable and animal oils. Accordingly, in one embodiment the oil is selected the group consisting of vegetables oil and animal oil. Animal oils include fish oil. In a further embodiment, the oil is selected the group consisting of vegetables oil and fish oil. In an embodiment of the present invention the oil is fish oil. The fish oils in the context of the present invention include but are not limited to salmon oil, mackerel oil, lake trout oil, herring oil, sardine oil, albacore tuna oil, cod liver oil, sand eel oil (Ammodytes tobianus), and menhaden oil. In one embodiment, the oil is selected from the group consisting of salmon oil, mackerel oil, lake trout oil, herring oil, sardine oil, albacore tuna oil, cod liver oil, sand eel oil (Ammodytes tobianus), and menhaden oil. In a further embodiment, the fish oil is salmon oil. The oil may be refined oil, a crude oil or a mixture of oils. Thus, in one embodiment the oil is crude fish oil.

The source of the oil may also be suitable vegetable oils. Thus in one embodiment, the oil is a vegetable oil, such as oil of flax or flax seed (commonly known as linseed), coconut oil, soybean oil, refined maize oil, corn oil, Canola oil, Sunflower oil, Corn oil, Olive oil, Peanut oil, Cottonseed oil, Lard, Palm oil, Butter, tung oil, castor oil, rice bran oil etc. In a further embodiment, the oil is linseed oil. In a further embodiment, the oil is linseed oil. Linseed oil has unique viscosity properties as described in the present application, which may make it a unique oil vehicle.

### Saturated Versus Unsaturated Fatty Acids

Oil such as vegetable oils and fish oil are compositions comprising saturated and unsaturated fatty acids. The group of unsaturated fatty acids includes mono-unsaturated fatty acids as well as poly-unsaturated fatty acids. The ratio of saturated to unsaturated fatty acids varies among oils. For dietary application oils rich in unsaturated fatty acids are highly preferred due to the health benefits of the unsaturated fatty acids over the saturated fatty acids. Thus, the oil used in the suspension is preferably rich in unsaturated fatty acids. Thus, in one embodiment, the oil is rich in unsaturated fatty acids such as mono-unsaturated and/or poly-unsaturated fatty acids. Thus in one embodiment the ratio of saturated to unsaturated fatty acids in the oil is less than 20 to 1, such as 10 to 1, such as 5 to 1, such as less than 4 to 1, such as less than 3 to 1, such as less than 2 to 1, such as less than 1 to 1, such as less 1 to 5, such as less than 1 to 8, or such as less than 1 to 12. The content of unsaturated fatty acids in the oil may be higher than the content of saturated fatty acids such that the ratio of unsaturated to saturated fatty acids is 2 to 1 or more, such as 3 to 1 or more, such as 4 to 1 or more, such as 5 to 1 or more, such as 6 to 1 or more, such as 7 to 1 or more, such as 8 to 1 or more, such as 9 to 1 or more, such as 10 to 1 or such as 12 to 1. The ratio of saturated to unsaturated fatty acids varies among oils. For example, flaxseed oil comprises 9% of saturated fatty acids, 18% mono-unsaturated fatty acids, and 73% of polyunsaturated fatty acids. In contrast, coconut oil comprise 91% saturated fatty acids, 7% mono-unsaturated fatty acids, and 2% poly-unsaturated fatty acids.

In order to sustain the key health benefits and features of the food product, the product described in this invention shall comprise a high level of unsaturated fatty acids. Furthermore, the total amount of fats in the food product shall range 0.5% till 45% of net weight of the product, where preferably the ratio between saturated to unsaturated fats within the total fat content shall range 20/1-1/12.

Known health beneficial unsaturated fatty acids are omega-3 (n-3) fatty acids such as α-linolenic acid (ALA), eicosapentaenoic acid (EPA), and docosahexaenoic acid (DHA) and omega-6 (n-6) fatty acids such as linoleic acid and arachidonic acid. In general it is to be understood that the group of unsaturated fatty acids includes mono-unsaturated fatty acids and poly-unsaturated fatty acids.

Accordingly, in one embodiments of the invention the oil of the suspension comprises the unsaturated fatty acid selected from the group consisting of α-linolenic acid (ALA), eicosapentaenoic acid (EPA), and docosahexaenoic acid (DHA) and omega-6 fatty acids such as linoleic acid and arachidonic acid. In one embodiment the oil of the suspension is rich the unsaturated fatty acids, wherein the unsaturated fatty acids are n-3 fatty acids and n-6 fatty acids.

Thus in yet another embodiment the unsaturated fatty acids of the oil of the suspension comprises at least one of α-linolenic acid (ALA), eicosapentaenoic acid (EPA), docosahexaenoic acid (DHA), linoleic acid and arachidonic acid.

### Perioxide Level of Vehicle Oil

Another important parameter of the vehicle oil of the suspension is the peroxide level of the oil. Peroxides are intermediates in the autoxidation reaction and the peroxide level of the oil reflects the degree of rancidification oil and thus the quality of the oil. Apart from deterioration of fats and oils which form off-flavours and off-odour due to rancidification, a high level of peroxide also affects the preservation of the probiotic organism for which the oil is used as vehicle in the vacuum inclusion of the probiotic organism in an extruded food product. An oil with a low peroxide value is preferred as vehicle due to the better probiotic preservative properties over an oil with a higher peroxide value.

Accordingly, in one embodiment of the present invention the peroxide level of said oil is less that 6 meq O₂/kg oil, such as less than 5 meq O₂/kg, such as less than 4 meq O₂/kg, such as less than 3 meq O₂/kg. In a preferred embodiment of the present invention the peroxide level of the oil is less that 2 meq O₂/kg.

### Additive

The suspension of the invention may comprise at least one additive. Thus in one embodiment of the invention the suspension for vacuum infusion of an extruded food product comprises an additive such as an antioxidant. The additive may serve at least the function of preserving the oil vehicle component for example by reducing the accumulation of peroxide in the oil. By minimizing the accumulation of peroxide in the oil the quality of the oil is maintained during storage of the probiotic extruded food product. Oils with a high degree of unsaturation are most susceptible to autooxidation. The peroxide value of the oil also affects the preservation of the probiotic organism for which the oil is used as vehicle in the vacuum inclusion of the probiotic organism in an extruded food product. Accordingly, adding an antioxidant to the suspension reduce autooxidation reaction of the thereby maintaining the quality oil the oil in terms of food quality but also in terms of preserving the probiotic comprised in the probiotic food product and a fixed level of the unsaturated fats.

Thus, in one embodiment of the invention the suspension comprises at least one additive. In a further embodiment, the suspension comprises an antioxidant. In yet another embodiment, the antioxidant is selected from the group consisting of natural antioxidants and synthetic antioxidants. In one embodiment of the invention the synthetic antioxidant is selected from the group consisting of BHA and BHT and natural antioxidant is selected from the group consisting of Vitamin E, flavonoids, and polyphenolics. The natural antioxidant may be provided in the form of an extract for example rosemary or grape seed extracts (comprising resveratrol).

Preferably, natural antioxidants are used. Accordingly, in yet another embodiment the antioxidant is natural antioxidant selected from the group consisting of flavanoids, cartonoids, tocotrienol, tocopherol and terpenes. In a particular embodiment, the antioxidant is astaxanthin.

### Dynamic Viscosity

Besides the preservative effects of the oil it may also be beneficial if the oil is easily vacuum infused. It may also be beneficial if the oil does not cause any problems during the manufacturing process of the probiotic food product. Thus, in yet an embodiment the oil vehicle has a dynamic viscosity of less than 0.08 pascal-second (Pa·s) at 20° C., such as between 0.01-0.09, such as between 0.03-0.09, such as between 0.04-0.08, or such as between 0.06-0.08 pascal-second. A low viscosity may increase the infusion rate during the vacuum infusion. Furthermore, when the oil vehicle comprising probiotics is sprayed onto the food product, during manufacturing, a low viscosity may minimize the risk of clotting in the spraying nozzles.

### Fructo-Oligosaccharide (FOS)

Since the product of the invention comprises below 10% of sugar, it may improve the taste and odour of the product to add an alternative sweetener. Thus, in an embodiment at least part of the oligosaccharides are natural sourced fructo-oligosaccharides. Besides improving taste and odour of food products, FOS serves as a substrate for microflora in the large intestine, increasing the overall gastrointestinal tract health. Thus, FOS are considered as prebiotics.

Inulin also can serve as a prebiotic compound in the food product described in current invention.

Inulins are a group of naturally occurring polysaccharides (several simple sugars linked together) derived from many types of plants.

Inulins are polymers mainly comprising fructose units and typically have a terminal glucose. The fructose units in inulins are joined by a β(2→4) glycosidic bond. Plant inulins generally contain between 20 to several thousand fructose units. Smaller compounds are called fructo-oligosaccharides.

### Taste, Texture And Appearance

To make the food product of the invention attractive to consumers the product should have an appealing taste, texture and appearance. Thus, in an embodiment the food product has the taste, texture and appearance of a conventional product of the same type having a higher content of sugar.

In another embodiment the food product has the taste, texture and appearance of a conventional product of the same type without probiotics.

Evaluation of taste, texture and appearance can be evaluated using a standardized tasting panel.

### Honey

The food product may comprise additional sources of sweeteners. Thus in an embodiment the food product comprises at least one of honey, dried fruit, Yacon, natural syrup (such as Maple, Stevia, Sorghum etc.). Natural sourced sweeteners also are used for their content of fructo-oligosaccharides (FOS) and/or inulin, which act as prebiotic. In an embodiment the honey, dried fruit, Yacon, natural syrup (such as Maple, Stevia, Sorghum etc.) are comprised in a coating surrounding the other parts of the food product. Furthermore, the product may comprise or be covered with Raw honey, Barely malt, brown rice syrup, Agave syrup, Apple syrup, Stevia, evaporated fruit juices (Cherries, Grapefruit, Dried apricots, Pear, Apple, Plum, Peach, Orange, Grapes), unsulphured molasses, evaporated cane juice and grape juice concentrate.

### Probiotic Micro-Organism of the Product

The probiotic micro-organism(s) (probiotic(s)) are added to the extruded food product as supplement in order to improve the intestinal microbial balance of the host (such as human beingor pet). The probiotic micro-organism used by the present invention is preferably in preserved state such as freeze-dried. The size of the freeze-dried particles are from 1 μm and larger. In the freeze-dried form the probiotic micro-organism is in a metabolic state of life as a consequence of cryopreservation. However, the probiotic micro-organism will revert into a metabolic state of life when exposed to an environment enabling the metabolic state of life and populate the environment such as the intestinal of the host.

Accordingly, a non-viable (dead) micro-organism is not a probiotic micro-organism.

The state of preservation is further sustained by the use of the oil in the suspension of the invention. Thus, apart from serving the purpose of vehicle for infusion of the probiotics into the extruded food product, the oil also function as a preservation of the probiotic micro-organism embedded in the food product. Thereby, the stability of the probiotic food product is improved and the shelf life of the final food product increased.

Probiotics are diverse and identified both among bacteria and fungi. Probiotic micro-organism from both kingdoms are suitable in the context of the present invention.

In one embodiment, the food product of the invention comprises at least one probiotic micro-organism is selected from the group consisting of bacteria, yeast and mold. In another embodiment of the invention, the at least one probiotic micro-organism is bacteria selected from the group consisting of Bifidobacterium, Bacteroides, Clostridium, Fusobacterium, Melissococcus, Propionibacterium, Streptococcus, Enterococcus, Lactococcus, Kocuriaw, Staphylococcus, Peptostrepococcus, Bacillus, Pediococcus, Micrococcus, Leuconostoc, Weissella, Aerococcus, Oenococcus and Lactobacillus.

In further embodiment, the at least one probiotic micro-organism is bacteria selected from the group consisting of Bifidobacterium, Bacteroides, Clostridium, Fusobacterium, Melissococcus, Propionibacterium, Streptococcus, Enterococcus, Lactococcus, Kocuriaw, Staphylococcus, Peptostrepococcus, Bacillus, Pediococcus, Micrococcus, Leuconostoc, Weissella, Aerococcus, Oenococcus and Lactobacillus.

In yet another embodiment of the invention, the at least one probiotic is a yeast selected from the group consisting of Saccharomyces, Debaromyces, Candidaw Pichia and Torulopsis. In one embodiment of the invention, the at least one probiotic is a mold selected from the group consisting of Aspergillus, Rhizopus, Mucor, and Penicillium and Torulopsis.

In yet an embodiment of the invention, the probiotic micro-organism is selected from the group consisting of Aspergillus niger, A. oryzae, Bacillus coagulans, B. lentus, B. licheniformis, B. mesentericus, B. pumilus, B. subtilis, B. natto, Bacteroides amylophilus, Bac. capillosus, Bac. ruminocola, Bac. suis, Bifidobacterium adolescentis, B. animalis, B. breve, B. bifidum, B. infantis, B. lactis, B. longum, B. pseudolongum, B. thermophilum, Candida pintolepesii, Clostridium butyricum, Enterococcus cremoris, E. diacetylactis, E. faecium, E. intermedius, E. lactis, E. muntdi, E. thermophilus, Escherichic coli, Kluyveromyces fragilis, Lactobacillus acidophilus, L. alimentarius, L. amylovorus, L. crispatus, L. brevis, L. Casei, L. curvatus, L. cellobiosus, L. delbrueckii ss. bulgaricus, L farciminis, L. fermentum, L. gasseri, L. helveticus, L. lactis, L. plantarum, L. johnsonii, L. reuteri, L. rhamnosus, L. sakei, L. salivarius, Leuconostoc mesenteroides, P. cereviseae (damnosus), Pediococcus acidilactici, P pentosaceus, Propionibacterium freuclenreichii, Prop. shertnanii, Saccharontyces cereviseae, Staphylococcus carnosus, Staph. xylosus, Streptococcus infantarius, Strep. Salivarius ss. thermophilus, Strep. thermophilus, Strep. lactis.

The choice of probiotic organism depends on the specific application in question e.g. the type of food. Enterococcus faecium is suitable for probiotic dog food. Thus, in an embodiment the at least one probiotic micro-organism is Enterococcus faecium. The suspension may subsequently be used for the preparation of a probiotic extruded food product for dogs (e.g. a probiotic dog food kibble comprising Enterococcus faecium). In a particular embodiment, the at least one probiotic micro-organism is the NCIMB 10415 strain of Enterococcus faecium. The NCIMB 10415 strain may be EC No. 13 (E1707 (new classification)).

In one embodiment, the probiotic micro-organism is applied to the suspension in a dry powder form, wherein the concentration of the probiotic micro-organism in the dry powder is in the range of 10⁹-10¹⁷ CFU/kg dry powder, such as 10⁹-10¹⁶, such as 10¹⁰-10^{16, such as} 10¹⁰-10¹⁵ CFU/kg dry powder, such as 10¹⁰-10¹⁴ CFU/kg dry powder.

### Production Method

The food product of the invention can be prepared by a method according to the invention. Thus in another aspect the invention relates to a method for producing synbiotic extruded human food product with a ratio between saturated to unsaturated fatty acids of the total fat content of less than 20/1, said method comprising the steps of
providing a first extruded component having a sugar content of less than 10% and a density of 1 g/L to 1000 g/L at RT,
providing a suspension having a dynamic viscosity of less than 0.08 pascal-second (Pa·s) at 20° C., wherein said suspension comprises an oil/fat and at least one probiotic micro-organism having a concentration of 10⁷-10¹⁷ CFU/kg of the oil/fat,
providing a source of inulin and/or FOS,
   adding the first components to a vacuum infusion tank, and
a) reduce the pressure in the vacuum infusion tank to [0.2-0.95 bar]
b) vaporize the suspension at a temperature of 15-30° C.,
c) restore pressure to [1 bar], and
   coating the product obtained in c) with the source of inulin and/or FOS.

The ratio between saturated to unsaturated fatty acids in total fat content also influences the health benefits of the product. In order to sustain the key health benefits and features of the food product, the food product described in this invention may comprise a high level of unsaturated fatty acids. Furthermore, the total amount of fats in the food product may range from 0.5% till 45% of net weight of the product, where preferably the ratio between saturated to unsaturated fats within the total fat content shall range 20/1-1/12. Thus, in yet an embodiment of the invention, the ratio between saturated to unsaturated fatty acids is 20/1 to 1/1, such as 15/1 to 1/1, such as 10/1 to 1/1, such as 5/1 to 1/1, such as 1/1, such as 1/1 to 1/4, such as 1/1 to 1/8, or such as 1/1 to 1/12.

Known health beneficial unsaturated fatty acids are omega-3 fatty acids such as α-linolenic acid (ALA), eicosapentaenoic acid (EPA), and docosahexaenoic acid (DHA) and omega-6 fatty acids such as linoleic acid and arachidonic acid. Thus in yet an embodiment the unsaturated fatty acids in the product comprises at least one of α-linolenic acid (ALA), eicosapentaenoic acid (EPA), docosahexaenoic acid (DHA), linoleic acid and arachidonic acid.

To sustain the health benefits of the food product described in this invention the first component may or may not include sugar. If the first component should not comprise any sugar the level in the final food may becomes 0%. If the product should comprise sugar the total amount may range from 0.1-10 wt %. Thus, in another embodiment the content of sugar in the first component is 0-10 wt %, such as 0.1-8 wt %, such as 0.1-6 wt %, such as 0.1-4 wt %, such as 0.5-4 wt %, or such as 1-4 wt %, or such as 2-3 wt %.

The first component described in this invention should initially be extruded as part of conventional production process since extruded products develop a rigid structure and maintains a porous texture. The density of the first component may vary depending on the type of first component. Thus, in an embodiment the density is 200 g/L to 1000 g/L, such as 400 g/L to 1000 g/L, such as 600 g/L to 1000 g/L, such as 1 g/L to 500 g/L or such as 100 g/L to 500 g/L.

Pressure In Vacuum Infusion Tank

During the infusion process the pressure in the vacuum infusion tank needs to be maintained at certain pressures in the range of 0.2-0.95 bar. In another embodiment the pressure inside vacuum infusion tank can be adjusted to pressures in the range of 0.01 bar-1.5 bar, such as 0.01 bar-1.5 bar, such as 0.05 bar-1.5 bar, such as 0.05 bar-1 bar, such as 0.1 bar-1 bar, such as 0.05 bar-0.1 bar, such as 0.1 bar-0.3 bar, such as 0.3 bar-0.5 bar, such as 0.5 bar-0.7 bar, or such as 0.7 bar-0.95 bar. By having the possibility also to increase the pressure above 1 bar a larger pressure difference may be achieved following pressure release, which may result in a better vacuum infusion.

### Temperature of the Suspension During Vaporization

The temperature of the suspension during vaporization should be in the range of 15-30° C. Thus, in a further embodiment the temperature of the suspension during vaporization is 15-30° C., such as 20-30° C., or such as 22-28° C., or such as 25° C. Keeping the temperature inside the defined range may improve the viability of the probiotics in the final product.

### Pressure Release

Restoration of the pressure to 1 bar may be performed by a slow release of the pressure such as by an average speed of 0.05 bar to 1 bar per minute, such as 0.1 bar to 1 bar per minute, such as 0.15 bar to 1 bar per minute, such as 0.2 bar to 1 bar per minute, such as 0.25 bar to 1 bar per minute, such as 0.25 bar to 0.8 bar per minute, such as 0.25 bar to 0.7 bar per minute, such as 0.25 bar to 0.6 bar per minute, such as 0.25 bar to 0.5 bar per minute. Furthermore to achieve the required result in manufacturing food product described in this invention, the manufacturing process has to involve a vacuum infusion stage. At the stage of vacuum infusion the number of vacuum cycles, pressure and timing shall be calibrated according to: type of product manufactured, type of vacuum system used in production line, composition of the suspension comprising probiotic microorganisms needed for the specific food product.

### Extruded Cereal Product

Extruded products can be supplied from different sources. Therefore, in a further embodiment the first component is an extruded cereal product. Furthermore, many different types of cereal products may be used in the method of the invention. Therefore, in yet a further embodiment the cereal product is selected from the group consisting of extruded snack products, tortilla chips, breakfast cereals, cookies, crisp bread, food foams, Rice brokens, blend of peanut, soybean and corn, puffed wheat, low density foamed corn and rice breakfast, co-extruded products, muesli bars and any other extruded products that are formed by an extrusion process. The different types of extruded cereal products may all benefit from probiotic microorganisms.

### Temperature of Extruded Product

During the vaporization not only the temperature of the oil suspension but also the temperature of the extruded product influences the viability of the probiotics. Thus, in an embodiment the first extruded component has a temperature above 15° C. when the suspension is vaporized on the first extruded component, such as a temperature of 15-50° C., such as 20-50° C., such as 20-45° C., such as 20-40° C., such as 20-35° C., or such as 20-30° C. without resulting in significant loss of viability of the probiotics. Freshly extruded food product with a temperature above 15° C. has increased properties of absorbing the suspension. Thus, a higher amount of solutions/suspensions may be infused into the product when the product has a temperature above 15° C. But the temperature should also not exceed 50° C. if the viability count should not be strongly affected. If the suspension comprises a very high count of viable probiotics, this may compensate for loss of viability due to infusion into a first component having a temperature in the range of 30-90° C.

### Origin of Oil

The oil used for producing synbiotic extruded human food product may have different origins. Thus in an embodiment of the invention the oil is selected from the group consisting of oil from mackerel, lake trout, herring, sardines, salmon or albacore tuna, sand eel, Ammodytes tobianus, and menhaden.

In another embodiment the oil is selected from the group consisting of linseed oil, olive oil, borage oil, lin oil, camelina oil, grape seed oil, chia oil, kiwifruit seeds oil, perilla oil, lingonberry, purslane oil, seabuckthorn oil, hemp oil.

### Time In Suspension

The probiotics in the suspension may be contaminated if care is not taken. Thus, in an embodiment the suspension is coated (introduced) on a product within 5 hours after the mixing of the oil/fat with the probiotics. The longer the probiotic suspension is in the liquid form (at least until the vacuum infusion) during the manufacturing process the higher is the risk for contamination. Therefore in an additional embodiment, the probiotic suspension is coated on food product within 5 minutes to 5 hours after the mixing of the oil/fat with the probiotics, such as 15 minutes to 4 hours, such as 15 minutes to 4 hours, such as 30 minutes to 4 hours, such as 30 minutes to 3 hours, such as 30 minutes to 2 hours, or such as 1 to 2 hours.

### Fructo-Oligosaccharides

It may also be advantageously to include oligosaccharides in the food product, which have other beneficial effects than sweetening the food product. Thus, in yet an embodiment the oligosaccharides comprise fructo-oligosaccharides. FOS are supplements that promote thriving colonies of probiotic bacteria in the digestive tract. Fructo-oligosaccharides are naturally occurring sugars found in many fruits, vegetables and grains. These non-digestible complex carbohydrates resist digestion by salivary and intestinal digestive enzymes and enter the colon where they are fermented by probiotic bacteria. Inulin can be considered as a source of fructo-oligosaccharides. The most beneficial effect of fructo-oligosaccarides is the selective stimulation of the growth of probiotic bacteria, thus significantly enhancing the composition of the colonic microflora and reducing the number of potential pathogenic bacteria.

The food product may also receive oligosaccharides from other sources. Thus, in yet an embodiment the oligosaccharides are comprised in honey which is also a source of inulin.

Since honey may have a high viscosity it may be advantageously to coat onto the product by other means than vacuum infusion. Thus in another embodiment the food product is coated using free flow coating, spray coating, cold mixing etc. Such treatment may add an extra nutritional value to the final product as well as a protective layer for increasing probiotic micro-organism stability. Other coating than honey may be coated onto the product. Thus, in an embodiment the coating comprises natural sweeteners, artificial sweeteners, vitamins, tartar or other additives or the like. For example, the product may comprise or be covered with Raw honey, Barely malt, brown rice syrup, Agave syrup, Apple syrup, Maple syrup, Stevia, evaporated fruit juices (Cherries, Grapefruit, Dried apricots, Pear, Apple, Plum, Peach, Orange, Grapes), unsulphured molasses, evaporated cane juice and grape juice concentrate.

Oligosaccharides such as fructo-oligosaccharides and polysaccharides such as inulin, may not need to be comprised in honey. Thus, in an embodiment fructo-oligosaccharides and/or inulin are coated on the food product.

### Production Plant

It may be advantageously to have a production plant facility to produce a product according to the invention using the production method according to the invention. Thus, in one aspect of the invention, the invention relates a production plant for vacuum infusing a human cereal food product comprising
a first storage tank for storing a probiotic suspension, connected to a first dosage tank for dosing a probiotic suspension,
   wherein the first dosage tank is connected to a vacuum infusion tank by one or more spraying nozzles leading into the vacuum infusion tank.

In this way the probiotic suspension may be sprayed onto the food product positioned in the vacuum infusion tank.

### Orifice of Spraying Nozzles

Depending on the solution/suspension different requirements apply to the spraying nozzles. Thus, in a further embodiment the invention relates to a production plant, wherein the orifice of each of the spraying nozzles has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm². The importance of having optimal nozzles for each type of solution is that the efficiency of the spraying is depending on the orifice of each of the spraying nozzles, the viscosity of the solution passing through the nozzle, the concentration of probiotics in the suspension, the strains of probiotics (yeast are much larger than bacteria and behave differently in a solution) also depend on the speed the solution is passed through the nozzle.

### Mixing Tank

To be able to maintain a high viability of the probiotics during the whole process of vacuum infusion, correct handling of the solution is required. Thus, in yet a further embodiment the invention relates to a production plant, wherein a first mixing tank is connected to the first storage tank through a bottom outlet in the first mixing tank, and where the probiotic suspension is intended for being passed from the first mixing tank to the first storage tank at least by means of gravity, possibly by means of gravity only. An advantage of having an additional mixing tank is that mixing dried probiotics into the oil/fat suspension may result in flakes/precipitates of microorganisms if the microorganisms are added too fast to the suspension. Furthermore, manually mixing may be advantageously. An example of a mixing tank is an IBC tank.

### Proviso For Vacuum Suction Unit And A Positive Displacement Unit

When the suspension is transferred to the first storage tank it is also important not to supply too much force to the suspension since it may result in loss of viability of the probiotics. By having an outlet positioned at the bottom of the mixing tank and the first storage tank positioned below the mixing tank, the suspension can be transferred to the storage tank only by the force of gravity. Thus, in an embodiment the connection between the first mixing tank and the first storage tank does not comprise a vacuum suction unit. In another embodiment the connection between the first mixing tank and the first storage tank does not comprise a positive displacement unit. Both a vacuum suction unit and a positive displacement unit may be harmful to the viability of the probiotics. Furthermore by minimizing the surfaces the probiotics come in contact with, loss of probiotics due to sticking to the surfaces of e.g. long tubes, loss of viability may also be avoided.

### Mixing Means

It is important that the probiotics stay/become evenly distributed in the suspension when the suspension is maintained in the first storage tank. Thus, in a further embodiment the first storage tank comprises at least one of the following means for mixing: a rotating impeller, a rotating mixing tank, or a combination of an impeller and a rotating tank. By having the first storage tank comprising means for mixing, such as an impeller, a rotating tank or a combination of both, sedimentation of the probiotics may be avoided. The person skilled in the art would know of other means for mixing which may be suitable for the described purpose.

### Opening For Uncoated Food Product

The vacuum infusion tank also has to be able to receive the food product (not yet infused) before the vacuum infusion begins. Thus, in yet an embodiment the vacuum infusion tank comprises at least one opening for applying the uncoated food product to said vacuum infusion tank. The food product (before infusion) may be transferred to the vacuum infusion tank directly from a drying device, which means that the un-infused food product may have a temperature above ambient temperature when it enters the vacuum infusion tank.

### Drying Device

Thus, in an embodiment the vacuum infusion tank is connected to a drying device. A higher amount of solutions/suspensions are being infused into the product when the product has a temperature of 15-60° C., such as 20-45° C., such as 20-40° C., such as 20-35° C., or such as 20-30° C. without resulting in significant loss of viability of the probiotics.

### Pressure In Vacuum Infusion Tank

The vacuum infusion tank may be constructed to decrease the pressure inside the tank to a vacuum. Thus, in an embodiment the pressure inside vacuum infusion tank can be adjusted to pressures in the range of 0.01 bar-1.5 bar, such as 0.01 bar-1.5 bar, such as 0.05 bar-1.5 bar, such as 0.05 bar-1 bar, such as 0.1 bar-1 bar, such as 0.05 bar-0.1 bar, such as 0.1 bar-0.3 bar, such as 0.3 bar-0.5 bar, such as 0.5 bar-0.7 bar, or such as 0.7 bar-0.95 bar. By having the possibility also to increase the pressure above 1 bar a larger pressure difference may be achieved following pressure release, which may result in a better vacuum infusion.

### Collection Vessel

Following vacuum infusion the food product (now comprising probiotics) may require additional coatings, which is not vacuum-infused. Thus, in a further embodiment the vacuum infusion tank is further connected to a collection tank for passing the coated food product from the infusion tank to the collection tank, and wherein the collection tank is further connected to at least one vessel containing one or more substances to be applied to the collection vessel. Since not all solutions are suitable for being applied to a product through spraying, e.g. due to a high viscosity or because the solution comprises components which due to the size may clot the spraying nozzles other means for applying such solutions may be required. Furthermore, applying additional means for adding a solution to the vacuum infusion tank, may be inappropriate since high viscosity solutions may still result in damage to the spraying nozzles already positioned inside the vacuum infusion tank. The collection tank may receive a solution from one or more vessels by e.g. a standard tube, pibe or hose.

### Mixing Means

It may become difficult to get the one or more solutions evenly distributed on the vacuum infused food products. Thus, in yet a further embodiment the collection tank comprises at least one of the following means for mixing: a rotating impeller, a rotating mixing tank. The person skilled in the art would know of other means for mixing.

### Temperature Control

It is important to provide environmental conditions during the whole production, which are advantageously for the viability of the probiotics. Thus, in an embodiment at least the first storage tank and the first dosage tank comprise means for maintaining the temperature of the probiotic suspension in the range of 15° C. to 29° C. Probiotics are in general sensitive towards temperatures variations therefore control of temperature is advantageously. Furthermore, to provide products which have a constant viability count between different productions sessions, temperature control of at least some of the tanks which comprises probiotics may be an advantage.

### Second Storage Tank And Second Dosage Tank

It may be advantages to be able to vacuum infuse other suspension into the food products. Thus in a further embodiment the production plant further comprises
a second storage tank for storing a second solution, connected to a second dosage tank for dosing the second solution,
   wherein the second dosage tank is connected to a vacuum infusion tank by one or more spraying nozzles leading into the vacuum infusion tank, and wherein the first dosage tank is individually connected to a vacuum infusion tank by one or more spraying nozzles leading into the vacuum infusion tank. In the production plant of the disclosed invention the probiotic suspension is kept separate from the other solution which may be vacuum infused into the product. This is done having the first dosage tank individually connected to the vacuum infusion tank. An advantage is that optimal viability of the probiotics is maintained when the probiotic oil/fat suspension is kept distinct from the other solution.

### Third Storage Tank And Third Dosage Tank

The production plant may comprise more than two infusion lines. It is to be understood that “infusion line” refers to the combination of vessels leading to the vacuum tank, e.g. the second storage tank leading to the second dosage tank leading to the vacuum infusion tank through one or more spraying nozzles. Thus, in a further embodiment the invention relates to a production plant further comprising
a third storage tank for storing a third solution, connected to a third dosage tank for dosing a third solution through one or more spraying nozzles, and
   wherein the third dosage tank is connected to a vacuum infusion tank by one or more spraying nozzles leading into the vacuum infusion tank.

### Fourth Storage Tank And Fourth Dosage Tank

Similar, in yet a further embodiment the invention relates to a production plant further comprising
a fourth storage tank for storing a fourth solution, connected to a fourth dosage tank for dosing the fourth solution,
   wherein the fourth dosage tank is connected to a vacuum infusion tank by one or more spraying nozzles leading into the vacuum infusion tank.

The fourth storage tank and the fourth dosage tank may be optimized for storing additional solutions. The solutions in the second dosage tank, the third dosage tank and the fourth dosage tank may be connected to the vacuum infusion tank through a joined connection, which may make the plant simpler to construct.

It may also be advantageously to avoid intermixing of some of the solutions present in the dosage tanks. Thus, in another embodiment the invention relates to a production plant, wherein at least one of the following dosage tanks also is individually connected to the vacuum infusion tank by one or more spraying nozzles: the second dosage tank, the third dosage tank and the fourth dosage tank.

This may be advantageously, since intermixing of two or more of the different solutions may result in precipitation and clotting of the spraying nozzles.

In some cases none of the solutions in the dosage tanks should be intermixed before they enter the vacuum infusion tank. Therefore, in yet another embodiment the invention relates to a production plant, wherein each of the following dosage tanks also is individually connected to the vacuum infusion tank by one or more spraying nozzles: the second dosage tank, the third dosage tank and the fourth dosage tank. This may be advantageously, since intermixing of two or more of the different solutions may result in precipitation and clotting of the spraying nozzles. Another advantage may be that e.g. the fourth storage tank and the fourth dosage tank can be saved as an extra infusion line in the case that e.g. the nozzles in one of the dosage tanks clots. In this way a fast switch can be made to the fourth infusion line and thus save expensive “down-time” where the plant may be out of order.

### Orifice of Each of the Spraying Nozzles

Therefore, in an additional embodiment the orifice of each of the spraying nozzles connected to the first dosage tank has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm², and the orifice of each of the spraying nozzles connected to the second dosage tank has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm², and the orifice of each of the spraying nozzles connected to the third dosage tank has a cross-sectional area of 1-250 mm², possibly 1-200 mm², such as 1-150 mm², or 1-100 mm², or 1-50 mm², or 1-25 mm², or 1-15 mm2 or 1-10 mm2 or 1-5 mm2 or 1-3 mm2, and the orifice of each of the spraying nozzles connected to the fourth dosage tank has a cross-sectional area of 1-250 mm², possibly 1-200 mm², such as 1-150 mm², or 1-100 mm², or 1-50 mm², or 1-25 mm², or 1-15 mm² or 1-10 mm² or 1-5 mm² or 1-3 mm². Thus, it is to be understood that each infusion line do not necessary have the same type of spraying nozzles.

### Control Unit

It may be difficult to control the production plant manually, since it comprises many individual components. Thus, in a further embodiment the plant further comprises a control unit for controlling at least one of the activities selected from the group consisting of: controlling the temperature in at least one of the storage tanks, controlling the temperature in at least one of the dosage tanks, controlling opening and closing of inlets and outlets between two or more of the tanks, controlling the amount of liquid sprayed through the nozzles, controlling the pressure in the vacuum tank and controlling the mixing time.

### Human Extruded Food Product Obtainable By The Method of the Invention

The products according to the invention may be obtained methods disclosed in the present invention. Thus, in an aspect of the invention a vacuum infused synbiotic human extruded food product is obtained by the methods of the invention

Similar, in another aspect of the invention, a probiotic cereal food product comprising at least one probiotic microorganism, wherein said probiotic micro-organism is infused in said food product, is obtained by the methods of the invention.

It should be noted that embodiments and features described in the context of one of the aspects of the present invention also apply to the other aspects of the invention. Thus, e.g. embodiments disclosed under the aspect relating to a food product may also apply the embodiments disclosed under aspects relating to production methods and production plants.

All patent and non-patent references cited in the present application, are hereby incorporated by reference in their entirety.

The invention will now be described in further details in the following non-limiting examples.

### EXAMPLES

### Example 1

### Measuring the Viscosity of Selected Oils

Equipment: Dynamic rheometers Physica MCR 301 (Anton Paar GmbH, Germany), C-PTD200 Peltie temperature control and CC27 coaxial cylinder measuring system (in/out diameter 26.66 and 28.92 mm).

Method: The viscosity of the oils was measured at turning speed of 180 rpm; at temperature range of 5 to 50° C., heating rate was 0.5° C./min, viscosity was registered after each 1° C. Two parallels of samples were measured. The table of FIG. 2 lists the average viscosity (Pa·s) of the oils.

UPP, Belgium supplied:

1. Crude fish oil

2. Salmon oil A

3. Refined maize oil

4. Cod liver oil

Vobra Special Petfoods BV, Netherlands supplied:

5. Salmon oil B

6. Soybean oil (with antioxidant)

7. Sunflower oil (with antioxidant)

8. Linseed oil

9. Borage oil

Results: One of the oils, Salmon oil A, displays unique viscosity properties over the remaining oils tested in the present experiment. Although the viscosity of Salmon oil A at refrigerating temperatures is higher than the remaining fish oil, In the temperature range of range 20-25° C. Salmon oil A loose viscosity much faster with increasing temperature than the remaining oils tested. Accordingly, the change in the viscosity (ΔPa·s/° C.) of Salmon oil A with temperature increase (within the temperature range 20-25° C.) is different from the remaining oils tested in the experiment. The change in the viscosity (ΔPa·s/° C.) of crude fish oil, cod liver oil and salmon oil B is basically the same within the temperature range of 20-25° C.

Salmon oil A was chosen as carrier oil (vehicle) for preparation of a probiotic/oil suspension for manufacturing a probiotic extrusion product by vacuum inclusion of the suspension. Salmon oil A was preferred over the remaining oils due to the unique viscosity properties in the temperature range 20-25° C. The manufacturing process is performed in temperature range 20-25° C. and the use of Salmon A oil will avoid the clotting of a spraying tip (nozzle) of a vacuum coater and improve homogenous distribution of probiotics in the carrier oil. Additionally oil/probiotic mixture is rapidly mixed in the tank before pumping into a vacuum coater, thus formation of a probiotic flakes (non suitable for a vacuum coating) is avoided during the bacteria addition to the oil.

The viscosity of the analysed oils is equal at high temperatures (starting form 40° C.), but such high temperatures have severe effects on the viability of probiotic bacteria, and consequently on the CFU/kg of the final food product.

Taken together, viscosity of oils is influenced by the source of the oil and substances added to the oil. The oil for and the substances added to the affects the properties of the oils such as the viscosity. Accordingly, the properties of the oil have to be taken into account when choosing an oil as vehicle for infusion of probiotic micro-organism. Since, care should also be taken to ensure that the substances added to the oil in the preparation of the oil/probiotic suspension does not severely affect important parameters of the suspension such as the viscosity.

### Example 2

### Mixing of Probiotics And An Oil Solution To Obtain A Probiotic Suspension

The suspension can be obtained by mixing one probiotic micro-organism, in a dry powder form having a total concentration of 10⁹-10¹⁶ CFU/kg dry powder, into an oil. The concentration/inclusion rate in the final suspension should be 0.3-15 kg of the probiotic powder per 100 kg oil. When the probiotics are mixed into an oil the probiotics may precipitate if the powder is not mixed slowly into the oil. Thus, not all of the freeze-dried powder should be added at once. To maintain the viability of the probiotics, the temperature of the suspension should not exceed 30° C. The mixing may be performed in a mixing tank, such as an IBC container, under continuously stirring. This mixing may be performed manually. Preferably the obtained suspension is transferred to a storage tank comprising mixing means. The transfer from the mixing tank to the storage tank is preferably done through a bottom outlet in the mixing tank into the storage tank (thus the mixing tank is physically positioned above the storage tank). The suspension is then mixed in the storage tank at a temperature of 5-30° C. (the mixing may be performed by rotation at 5-350 RPM) to obtain a suspension of homogenously dispersed probiotic micro-organism. The suspension should not be stored for longer than 3 hours in the storage tank before it is used in a vacuum infusion. If the suspension is stored for a longer time the suspension may become contaminated.

### Example 3

### Process Description

The example describes one embodiment of the invention relating to the method of the invention.

The stages of manufacturing after the drying stage as previous steps involve high temperatures that have an influence on probiotic micro-organisms. The method of further processing described in this invention is a vacuum infusion system.

Vacuum core liquid coating is the process, which is used to place the probiotic micro-organism within the matrix of the product. The particular stage in manufacturing process is carried out in a sealed environment.

Initial stages of the food product manufacturing (batching, grinding, extruding, drying) shall be carried out in a conventional manner and will depend on the type of the product being prepared as well as production in use. The oil/fat suspension comprising probiotic micro-organisms may be prepared prior to production and shall be stored in separate container until the introduction is needed.

Extruded non-coated product is coming out of dryer at a temperature of 15° C. to 60° C. depending on the product type required and specifications of the production line. Then the non-infused product is going into the drum of the vacuum infusion tank. The vacuum infusion tank is closing and starts moving (inside pressure 1 bar) the product and is creating the vacuum atmosphere. During the process the suspension is vaporised onto the product under vacuum condition (0.3-0.6 bar)

Temperature of liquid during process is 20° C. to 25° C. optimum 22° C. and preservation in container is 22° C. Normal pressure (1 bar) condition is restored inside the coater. If required the second cycle of liquid ingredients are sprayed onto the product under a new vacuum condition (0.6-0.9 bar). Normal pressure (1 bar) condition is restored inside the coater. The product type may then leave the vacuum infusion tank for further processing. The next steps may include: free flow coating, spray coating, cold mixing etc. Such treatment may add an extra nutritional value to the final product as well as protective layer for increasing probiotic microorganism stability.

### Example 4

### Salmon Oil As Oil Vehicle For A Human Food Product

The right choice of an oil as a probiotic compound carrier (oil vehicle) is based on the viscosity of the specific oil and the temperature which is needed to be implemented to achieve a particular viscosity. Together with the physical/chemical parameters of the oil which can have an influence on the viability of the probiotics, the organoleptic parameter of the specific oil also is a dramatic factor on an overall product taste and odor. In addition nutritional parameters also need to be considered. Thus, to find an oil vehicle which fulfils all these parameters is not an easy task.

### Organoleptic Parameters

In case of a probiotic human food product, a suspension with a salmon oil carrier may be used to produce an extruded dry human food product. Since salmon oil does not necessarily provide a taste or smell which is appealing to a human consumer, it is very crucial to find the particular oil vehicle for a probiotic compound which will not have an influence on a palatability of the final product based on a smell as major organoleptic parameter (for example linseed oil) Thus, if salmon oil is going to be used for human products it may be convenient to add components to the products which can cover the natural smell/taste of salmon oil. Such components may be sugars, natural sweeteners, honey. It is of course to be understood that for certain products it may not be necessary to cover the taste/smell of the oil.

### Nutritional Parameters

Together with above mentioned parameters, an oil used as an oil vehicle for probiotics needs to be “healthy”. High content of a saturated fatty acids, trans fatty acids and etc are generally considered as “unhealthy”. The high concentration of such fats furthermore minimizes the probiotic effect of the ready product and increases the risk of coronary heart disease by raising levels of “bad” LDL cholesterol and lowering levels of “good” HDL cholesterol. Salmon oil out of the animal fats (as well as linseed oil out of the vegetable fats) is well known for its unique composition of poly unsaturated fatty acids (omega 3 and omega 6) and thus is generally considered as “healthy” fat.

To be able to provide a product having the above mentioned properties and the same be optimal for vacuum infusion it has been discovered that the viscosity of the oil vehicle is important.

To be able to provide a product having the above mentioned properties and the same be optimal for vacuum infusion

### Viscosity

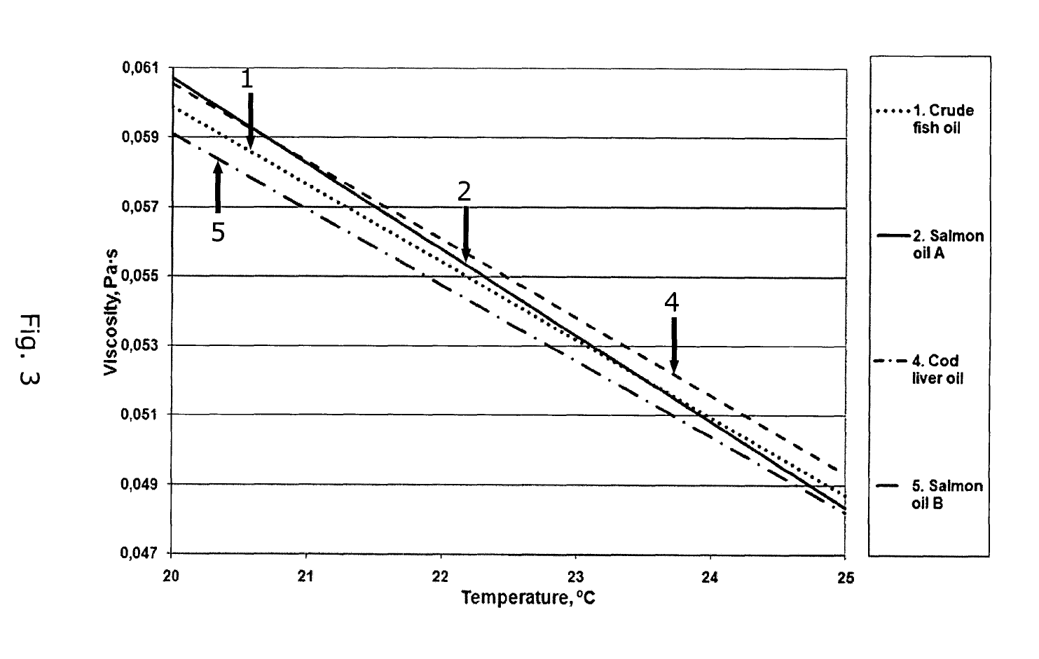

To find a salmon oil which also fulfils the criteria for being suited for vacuum infusion, viscosity of different salmon oils were compared. As shown in FIGS. 2 and 3 not all salmon oils have the same viscosity properties. The viscosity of salmon A decreases faster between 20° C. and 25° C. than does salmon oil B giving an extra advantage of usage of salmon oil A as a carrier (oil vehicle) of a probiotic compound. Salmon oils with such viscosity behaviour improve the mixing ability of the suspension together with equalized dispersal of the probiotic compound in the ready product and reduces sedimentation/wastes during the manufacturing stage with improvement of stability of the probiotic compound within the suspension and thus within the ready product.

Taken together salmon oil A becomes a suited oil vehicle for vacuum infusion of probiotics for food products such as human food.

It is to be understood that although the present example refers to human food it does not mean that salmon oil A cannot be used in animal products.

### Example 5

### Oil Vehicle/Suspension For Human Food Products

The right choice of an oil as a probiotic compound carrier (oil vehicle) is based on the viscosity of the specific oil and the temperature which is needed to be implemented to achieve a particular viscosity. Together with the physical/chemical parameters of the oil which can have an influence on the viability of the probiotics, the organoleptic parameter of the specific oil also is a dramatic factor on an overall product taste and odour. In addition nutritional parameters also need to be considered. Thus, to find an oil vehicle which fulfils all these parameters is not an easy task.

### Organoleptic Parameters

Usage of animal fats/oils in a human product is limited because of the organoleptic parameters which can have an overall effect on a palatability of the ready product. Thus, such animal oils, like different type of fish oils, may lead to resistance by the end consumer towards such products, even if the oil meets the health criteria's (e.g. as described in example 3). One way to overcome such problems is by covering the taste of fish oil as described in example 4. Alternatively a different source of oil should be used Thus, the oil used as a probiotic oil vehicle in a human product needs to meet the viscosity criteria required for optimal vacuum infusion but may have different organoleptic parameters than the oils used for animal products. Vegetable oils may be suitable candidates.

### Nutritional Parameters

Instead of using animal oil it may be advantageous also to be able to have a suitable oil vehicle with vegetable origin. Several vegetable oils have positive health parameters. Linseed oil compared with soy bean oil, maize oil and sunflower oil is considered as “healthy” oil with high concentration of poly unsaturated fatty acids (omega 3 and omega 6) and mild nutty taste. These parameters make linseed oil a suitable candidate as an oil vehicle for human product manufacturing.

### Viscosity

When comparing the viscosity of different oils with vegetable origin in the range of 20° C. and 25° C., it becomes apparent that linseed oil has unique properties for being used as an oil vehicle for vacuum infusion of probiotics (FIGS. 2 and 6). Linseed oil has the lowest viscosity at both 20° C. and 25° C. out of the vegetable oils analyzed. The curve of the linseed has got a small slope (low delta viscosity) but a low viscosity when compared to the other oils. Even when compared to the animal oils (FIGS. 2 and 6), linseed oils has the lowest viscosity at both 20° C. and 25° C.

Taken together, the viscosity of the linseed oil together with its unique physical/chemical and organoleptic parameters makes linseed oil a good candidate for usage as a probiotic oil vehicle for human product manufacturing.

It is to be understood that although the present example refers to human products it does not mean that linseed oil cannot be used in animal products.

### Example 6

### Viscosity of Suspension

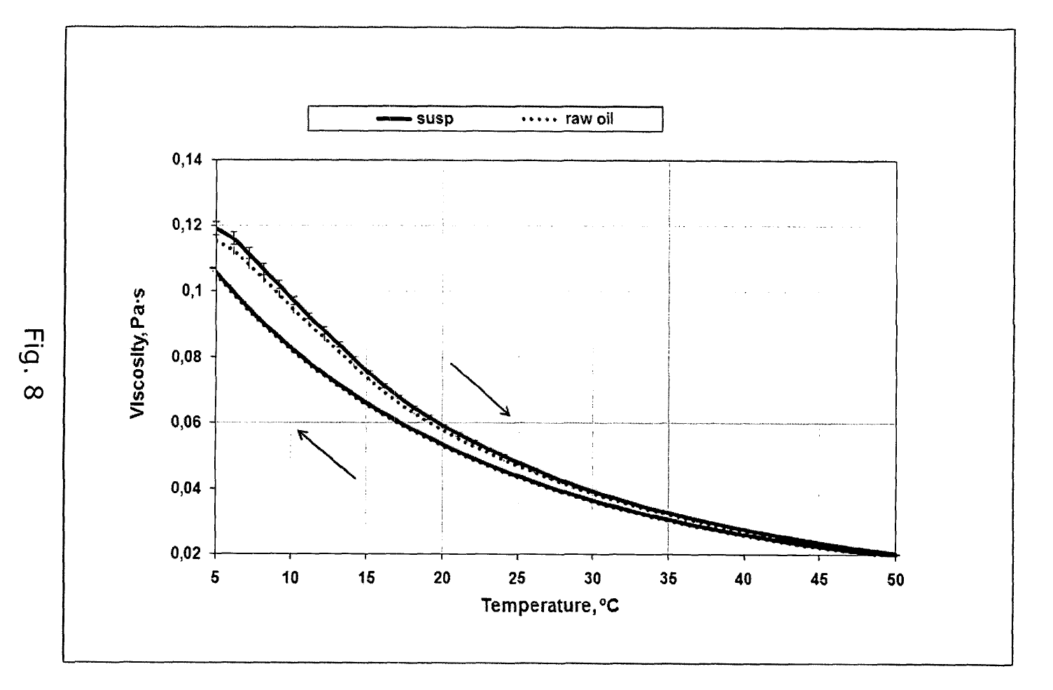

Since the viscosity of the final suspension is a key parameter when the suspension is going to be vacuum infused, the influence of the bacteria on the viscosity of the oil should be tested. FIG. 2 (lines 10-13) and FIG. 8 clearly show that the influence of the bacteria on the final viscosity at different temperatures is minimal. “Susp” (solid line) is salmon oil A with probiotics with a concentration/inclusion rate 1.2 kg/ton of final product. Raw oil (dashed line) is salmon oil A without probiotics. Top lines show the viscosity when the temperature is increased from 5-50 C°, whereas the bottom lines show the viscosity when the temperature is decreased from 50-5° C. In the bottom lines the dashed and solid lines are practically positioned on top of each other.

The difference is between the cooling and heating is likely due to residual heat in the analyzed samples.

FIG. 2 (lines 10-13) shows the viscosity of the raw salmon oil vs suspension viscosity at heating from 5° C. to 50° C. and backwards cooling from 50° C. to 5° C. At current inclusion rate which was used, the viscosity difference between both samples is minor with average of 0.001 Pa·s at each temperature step between both samples.

Δ visc. (20° C.-25° C.) of raw oil is 0.011 Pa·s at heating phase and 0.009 Pa·s at cooling phase.

Δ visc. (20° C.-25° C.) of suspension is 0.011 Pa·s at heating phase and 0.010 Pa·s at cooling phase.

Overall conclusion can be made that change of Δ visc. (20° C.-25° C.) of both samples at cooling and heating phases are minor and makes a 0.01 Pa·s in average.

In general there will be a difference between different measurements of the viscosity of a specific type of oil. This is likely due to the precise batch used and small variation in the way the samples are handled. Though such small variations are unavoidable the current invention clearly shows that the viscosity of the oil/suspension is indeed important for the viability of the probiotics in the final product.

### Example 7

Production of a vacuum infused probiotic product comprising probiotic bacteria optimized for human consumption.

### Set-Up

Two commercially available breakfast cereals: 4 grain snack—breakfast cereals “Neljavilja—krõbuskid” (AS BalSnack International Holding, Estonia) and Breakfast cereals—Flakes with cinnamon “Oho” (UAB Naujasis Nevė\check{z}is, Lithuania) were vacuum infused by usage of a probiotic/linseed oil suspension. Oil used in particular trial was linseed oil (OÜ Tervix, Estonia). Probiotic vacuum infused product was finally coated by low in glycemic index syrups. Commercially available probiotic bacteria formulation Protexin BALANCE (Protexin Healt Care, UK) and two different low in glycemic index syrups of Agave (Allos GmbH, Germany) and Maple (Cofradex ApS, Denmark) were used. Vacuum infusion was done by usage of Zepter VG-010 Vacsy Vacuum Pump with glass container VG-30 011-19 (Zepter International Group).

### Methods

150 grams of breakfast cereals per each product and per each batch were used. Daily dose of probiotics (1 capsules containing 1×10⁸ CFU, accordingly to the producer of probiotic compound) was added per 4.5 gr of the carrier (linseed oil) making a 3% (usual production ratio) out of the product amount to be infused.

Protexin BALANCE multi strain probiotic bacteria was gradually introduced into the carrier to receive a homogeneous suspension. Prepared suspensions (oil and probiotics) were continuously mixed on a Vortex prior the spraying to guarantee the homogeneity of the suspensions.

The sparing of the suspensions and syrups was done by usage of sprinklers. Before the vacuum infusion process the number of sprayings (by weight) was determined to receive a 3% coating by the bacteria suspension and 5% coating by the agave or maple syrup coating as a final layer (ratio taken from usual production data).

Prepared suspensions were used for a vacuum infusion into the matrix of a ready for consumption (extruded) human products. Multi-strain probiotic containing different suspensions were sprayed on different breakfast cereals appropriately in ratio of 4.5 gr to 150 gr of the product (3%). Afterwards product was coated by different syrups (agave vs maple) sprayed on different breakfast cereals appropriately in ratio of 7.5 gr to 150 gr of the product (5%). Product was mixed simultaneously with spraying to guarantee the equal dispersion of sprayed suspensions and coating syrups onto the different products used in the trial.

Spraying of the suspensions and mixing was done in one and the same vacuum infusion glass bowl sterilized prior the trial to eliminate the probiotic count reduction and contamination between intermediate processes. Glass bowel was closed with a special vacuum control lid and vacuum atmosphere (500 mBar and 630 liters/s) was created for approx. 40 seconds in the glass bowl containing the product (until the red indicator turning on the pump).

All syrups used for final layer coating (stage 2 coating) in particular trial were preheated up to 50° C. prior the coating process to have the best viscosity for spraying. Sprayings of appropriate suspensions and final coating layers were done in 2 separate stages corresponding to the suspension (linseed oil) and syrup type (agave vs maple).

Stage 1 (3% of product weight). During the process of vacuum coating, the prepared probiotic suspension was vaporized onto the appropriate product and vacuum pressure of 500 mbar was created for approx. 40 seconds. Normal atmospheric pressure (1 bar) conditions were restored inside the vacuum infusion device (glass bowl) by gradual opening of the pressure control system.

Stage 2 (5% of product weight). Preheated up to 50° C. final coating layer (agave vs maple syrup) was vaporized onto the product and vacuum pressure of 500 mbar was created for a 20 seconds. Normal atmospheric pressure (1 bar) conditions were restored inside the vacuum infusion device (glass bowl) by gradual opening of the pressure control system.

All different products coatings with different suspensions were done at 3 parallels.

All experiments were done at room temperature.

Coated with different suspensions products were sent to laboratory for a Total

Viable Count (TVC) analysis and a shelf-life trial of 1 months. All samples were shipped in sterile Falcon tubes each containing approx. 5 g of sample.

### Measurements

Each parallel was measured for 0 day (immediate) count, 2 weeks, 1 month interval. Each parallel was placed under 3 different storage conditions: refrigerated condition temperature of 6-8° C., standard condition temperature of 18-24° C., and condition temperature 36-38° C. Accelerated temperature conditions were considered as ×3 times faster, meaning that 1 month result of accelerated condition temperature equals to 3 month result at standard temperature condition, thus giving product stability at room temperature for 3 months.

All the TVC measurements of used raw materials are given in Table 1. and all TVC measurements of performed shelf-life trial are given in the Table 2.

TABLE 1
TVC measurements of used raw materials
Raw ingredients, TVC CFU/g

| | |
|---|---|
| Pillows bulk | 40 |
| Kibbles bulk | 10 |
| Raw bacteria powder | 9.00E+10 |
| Linseed/bacteria suspension | 1.60E+08 |

TABLE 2
TVC measurements of shelf-life trial, pillows vs kibbles

| Probiotic | Final | Storage | Bacteria count at different | | |
|---|---|---|---|---|---|
| suspension | coating | condition | time stages | | |
| carrier | layer | temp., ° C. | Day 0 | 2 week | 1 month |

Pillows, TVC CFU/g

| | | | | | |
|---|---|---|---|---|---|
| Linseed oil | Agave | 6-8 | 9.60E+05 | 9.20E+05 | 9.13E+05 |
| | | 18-24 | 9.60E+05 | 1.00E+06 | 1.25E+06 |
| | | 36-38 | 9.60E+05 | 7.23E+05 | 6.47E+05 |
| | Maple | 6-8 | 3.16E+06 | 2.23E+06 | 1.50E+06 |
| | | 18-24 | 3.16E+06 | 2.54E+06 | 1.95E+06 |
| | | 36-38 | 3.16E+06 | 8.93E+05 | 8.07E+05 |

Kibbles, TVC CFU/g

| | | | | | |
|---|---|---|---|---|---|
| Linseed oil | Agave | 6-8 | 7.73E+05 | 7.97E+05 | 7.47E+05 |
| | | 18-24 | 7.73E+05 | 8.80E+05 | 9.93E+05 |
| | | 36-38 | 7.73E+05 | 5.63E+05 | 4.63E+05 |
| | Maple | 6-8 | 1.63E+06 | 1.16E+06 | 1.13E+06 |
| | | 18-24 | 1.63E+06 | 1.00E+06 | 1.02E+06 |
| | | 36-38 | 1.63E+06 | 6.53E+05 | 5.57E+05 |

### Conclusions

Trial results clearly indicate that in initial Total Viable Count of bulk commercially available breakfast products (see Table 1, Pillows bulk and Kibbles bulk) showed dramatically lower counts than at the end of the trial after introducing the probiotic bacteria within the matrix of products under the trial (Table 2, 0 day count). This clearly indicates that the particular technology used for the vacuum infusion of the breakfast products (kibbles and pillows) described in the methods is suitable for the probiotic breakfast product manufacturing. Additionally the shelf-life study results (see Table 2) clearly indicate that both products used in particular trial (pillows and kibbles) have a good stability up to 3 months at the room temperature and all the Total Viable Count (TVC) fluctuations at different storage temperatures of different suspension carriers and final coating layers stay within 1 log.

Finalizing the trial results, all the products used in current trial together with different suspension carriers and final coating layers used, maintained the probiotic count on a sufficient level during the entire shelf-life trial period, which assures survivability of the sufficient amount of probiotic compound (daily dosage) through the stomach acids passage and further positive probiotic function implementation on a host (human) organism.

These results clearly indicate that different types of extruded food products (e.g. kibbles and pillows) may be vacuum infused with probiotics and maintain a high TVC over a longer period of time.

1. A vacuum infused synbiotic human extruded food product comprising
1) a density of 1 g/L to 1000 g/L at RT,
2) a sugar content of less than 10 wt %,
3) a total content of at least one of inulin and/or FOS ranging from 2.5-10 wt %, and
4) a ratio between saturated to unsaturated fatty acids in total fat content of less than 20/1,
wherein at least one strain of probiotics is evenly distributed in said food product in an oil vehicle and wherein the food product has a probiotic count of at least 10⁶ CFU/kg of dry matter.

2-47. (canceled)

48. The food product according to claim 1, wherein the food product is selected from the group consisting of: extruded snack products, tortilla chips, breakfast cereals, cookies, crisp bread, food foams, rice brokens, a blend of peanut, soybean and corn, puffed wheat, a low density foamed corn and rice breakfast, co-extruded products, and muesli bars or an extruded food product that is formed by an extrusion process.

49. The food product according to claim 1, with the proviso that the food product does not comprise a synthetic sweetener.

50. The food product according to claim 1, wherein the count of at least one probiotic is 10⁶-10¹⁹ CFU/kg.

51. The food product according to claim 1, wherein the glycemic index is 1-55.

52. The food product according to claim 1, wherein the oil is fish oil.

53. The food product according to claim 1, wherein the oil is selected from the group consisting of: salmon oil, mackerel oil, lake trout oil, herring oil, sardine oil, albacore tuna oil, sand eel oil, Ammodytes tobianus oil, menhaden oil, flax oil, flax and seed oil.

54. The food product according to claim 1, wherein the oil is salmon oil.

55. The food product according to claim 1, wherein the oil is a vegetable oil.

56. The food product according to claim 1, wherein the oil is selected from the group consisting of: linseed oil, olive oil, borage oil, lin oil, camelina oil, grape seed oil, chia oil, kiwifruit seeds oil, perilla oil, lingonberry, purslane oil, seabuckthorn oil, and hemp oil.

57. The food product according to claim 1, wherein the oil is linseed oil.

58. The food product according to claim 1, wherein the oil vehicle has a dynamic viscosity of less than 0.08 pascal-second (Pa·s) at 20° C.

59. The food product according to claim 1, wherein said at least one probiotic micro-organism is a bacteria selected from the group consisting of: Bifidobacterium, Bacteroides, Clostridium, Fusobacterium, Melissococcus, Propionibacterium, Streptococcus, Enterococcus, Lactococcus, Kocuriaw, Staphylococcus, Peptostrepococcus, Bacillus, Pediococcus, Micrococcus, Leuconostoc, Weissella, Aerococcus, Oenococcus and Lactobacillus.

60. The food product according to claim 1, wherein said at least one probiotic micro-organism is Enterococcus faecium.

61. The food product according to claim 1, wherein said at least one probiotic micro-organism is the NCIMB 10415 strain of Enterococcus faecium.

62. The food product according to claim 1, wherein said at least one probiotic is a yeast selected from the group consisting of: Saccharomyces, Debaromyces, Candidaw Pichia and Torulopsis.

63. The food product according to claim 1, wherein said at least one probiotic is a mold selected from the group consisting of: Aspergillus, Rhizopus, Mucor, Penicillium, and Torulopsis.

64. The food product according to claim 1, wherein the probiotic micro-organism is selected from the group consisting of: Aspergillus niger, A. oryzae, Bacillus coagulans, B. lentus, B. licheniformis, B. mesentericus, B. pumilus, B. subtilis, B. natto, Bacteroides amylophilus, Bac. capillosus, Bac. ruminocola, Bac. suis, Bifidobacterium adolescentis, B. animalis, B. breve, B. bifidum, B. infantis, B. lactis, B. longum, B. pseudolongum, B. thermophilum, Candida pintolepesii, Clostridium butyricum, Enterococcus cremoris, E. diacetylactis, E. faecium, E. intermedius, E. lactis, E. muntdi, E. thermophilus, Escherichic coli, Kluyveromyces fragilis, Lactobacillus acidophilus, L. alimentarius, L. amylovorus, L. crispatus, L. brevis, L. Casei, L. curvatus, L. cellobiosus, L. delbrueckii ss. bulgaricus, L farciminis, L. fermentum, L. gasseri, L. helveticus, L. lactis, L. plantarum, L. johnsonii, L. reuteri, L. rhamnosus, L. sakei, L. salivarius, Leuconostoc mesenteroides, P. cereviseae (damnosus), Pediococcus acidilactici, P pentosaceus, Propionibacterium freuclenreichii, Prop. shertnanii, Saccharontyces cereviseae, Staphylococcus carnosus, Staph. xylosus, Streptococcus infantarius, Strep. Salivarius ss. thermophilus, Strep. thermophilus, and Strep. lactis.

65. The food product according to claim 1, wherein at least part of the saccharides are at least one of natural sourced fructo-oligosacharide or natural sourced inulin.

66. The food product according to claim 1, having the taste, texture and appearance of a conventional product of the same type without probiotics.

67. The food product according to claim 1, wherein the food product further comprises honey.

68. A method for producing synbiotic extruded human food product with a ratio between saturated to unsaturated fatty acids of the total fat content of less than 20/1, said method comprising:
providing a first extruded component having a mono-saccharide content of less than 10% and a density of 1 g/L to 1000 g/L at RT,
providing a suspension having a dynamic viscosity of less than 0.08 pascal-second (Pa·s) at 20° C., wherein said suspension comprises an oil/fat and at least one probiotic micro-organism having a concentration of 10⁷-10¹⁷ CFU/kg of the oil/fat,
providing a source of inulin and/or FOS,
adding the first extruded component and the suspension to a vacuum infusion tank, and
a) reducing the pressure in the vacuum infusion tank to [0.2-0.95 bar];
b) vaporizing the suspension at a temperature of 15-30° C.;
c) restoring the pressure to [1 bar]; and
d) coating the product obtained after c) with the source of inulin and/or FOS.

69. The method for producing synbiotic extruded human food product according to claim 68, wherein the first component is an extruded cereal product.

70. The method for producing synbiotic extruded human food product according to claim 68, wherein the cereal product is selected from the group consisting of:
extruded snack products, tortilla chips, breakfast cereals, cookies, crisp bread, food foams, Rice brokens, a blend of peanut, soybean and corn, puffed wheat, a low density foamed corn and rice breakfast, co-extruded products, and muesli bars or an extruded product that is formed by an extrusion process.

71. The method for producing synbiotic extruded human food product according to claim 68, wherein the extruded component has a temperature above 15° C. when the suspension is vaporized on the extruded component.

72. The method for producing synbiotic extruded human food product according to claim 68, wherein the oil is tasteless and odourless.

73. The method for producing synbiotic extruded human food product according to claim 68, wherein the oil is selected from the group consisting of: oil from mackerel, oil from lake trout, oil from herring, oil from sardines, oil from salmon, oil from albacore tuna, oil from sand eel, oil from Ammodytes tobianus, and oil from menhaden.

74. The method for producing synbiotic extruded human food product according to claim 68, wherein the suspension is introduced on a product within 5 hours after the mixing of the oil/fat with the probiotics.

75. The method for producing synbiotic extruded human food product according to claim 68, wherein the saccharides comprise at least one of fructo-oligosaccharides and/or inulin.

76. The method for producing synbiotic extruded human food product according to claim 68, wherein at least part of the fructo-oligosaccharides and/or inulin are comprised in honey.

77. The method for producing synbiotic extruded human food products according to claim 68, wherein the fructo-oligosaccharides and/or inulin are coated on the food product.
